(19) United States
(12) Patent Application Publication
(10) Pub. No.: US 2023/0149248 A1
(43) Pub. Date: May 18, 2023

(54) METHODS AND SYSTEMS FOR DYNAMIC OCULAR TRAINING USING THERAPEUTIC GAMES

(71) Applicant: Case Western Reserve University, Cleveland, OH (US)

(72) Inventors: Mark Walker, Shaker Heights, OH (US); Michael Fu, Mayfield Heights, OH (US)

(21) Appl. No.: 18/056,249

(22) Filed: Nov. 16, 2022

Related U.S. Application Data
(60) Provisional application No. 63/264,162, filed on Nov. 16, 2021.
(60) Provisional application No. 63/383,900, filed on Nov. 15, 2022.

(51) Int. Cl. A61H 5/00; A63F 13/213; A63F 13/67

(52) U.S. Cl. CPC A61H 5/00; A63F 13/213; A63F 13/67; A61H 5/005; A61H 2201/5043; A61H 2230/00; A61H 2201/1604; A61H 2201/5007

(57) ABSTRACT

Methods and systems for dynamically prescribing therapeutic games for treatment of ocular disorder are disclosed. The methods and systems include: performing an eye position calibration technique in a virtual reality environment to calibrate the virtual reality environment to a user; performing an eye movement measurement to produce a diagnosis result; selecting a virtual reality therapeutic game based on the diagnosis result; performing the virtual reality therapeutic game to receive a game user input in the virtual reality therapeutic game; and dynamically adjusting difficulty of the virtual reality therapeutic game based on the game user input. Other aspects, embodiments, and features are also claimed and described.

### CROSS-REFERENCE TO RELATED APPLICATION(S)

This application claims the benefit of U.S. Provisional Patent Application Ser. Nos. 63/264,162 and 63/383,900, filed Nov. 16, 2021, and Nov. 15, 2022, respectively, the disclosures of which are hereby incorporated by reference in their entirety, including all figures, tables, and drawings.

### STATEMENT REGARDING FEDERALLY SPONSORED RESEARCH

This invention was made with Government support under grant/contract number I21RX002892 and I21RX003750, awarded by the United States Department of Veterans Affairs. The Government has certain rights in the invention.

### BACKGROUND

A history of traumatic brain injury (TBI) is common among military service members and veterans, often due to combat-related exposure to blast and/or blunt head trauma but also from other injuries. According to the Department of Defense TBI Center of Excellence, 458,894 U.S. active-duty service members were diagnosed with TBI between 2000 and the first quarter of 2022, of whom 82% had mild and 11% moderate TBI. Even though basic neurological function generally recovers after mild TBI, many individuals have lingering sensorimotor symptoms that interfere with their everyday functioning. Among the more common chronic persistent symptoms are problems with near vision that affect reading and other close work. That is because damage to the brainstem areas or their cortical and/or cerebellar inputs could affect both the ability to make the rapid changes in vergence needed to shift fixation from far to near and the ability to maintain steady convergence once it is achieved.

Despite its prevalence, clinical assessment of vergence and binocular vision is currently based largely on less precise bedside tests. Common measures include the near point of convergence (NPC)—the distance at which the images of a target can no longer be fused as that object is moved toward the eyes, phoria measurements, step and smooth vergence tests, measurements of accommodation (in younger individuals), and tests of stereopsis. Key limitations of bedside diagnostic tests include that: 1) they depend highly on examiner technique and are thus difficult to standardize, and 2) they are generally semiquantitative and are unable to measure vergence timing (latency) and dynamics (speed profile). In addition, treatment options for impaired near vision after TBI are limited. Thus, what are needed are systems and methods that address one or more of these shortcomings.

### SUMMARY

The following presents a simplified summary of one or more aspects of the present disclosure, to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some aspects of the present disclosure, methods, systems, and apparatus for dynamic ocular training are disclosed. These methods, systems, and apparatus can include steps or components for: receiving an indication of an ocular disorder of a patient; selecting a virtual reality therapeutic game from a set of available virtual reality therapeutic games, wherein each of the set of available virtual reality therapeutic games is designed to provide therapy for one or more of a given set of ocular disorders, the virtual reality therapeutic game being selected based on the indication of the ocular disorder, the selected virtual reality therapeutic game being designed to provide therapy for the ocular disorder; performing the virtual reality therapeutic game via a display screen to the patient, and receiving a patient input during performance of the virtual reality therapeutic game; determining a current success level of the patient for the virtual reality therapeutic game based on the patient input; and dynamically adjusting a difficulty level of the virtual reality therapeutic game based on the current success level of the patient.

In further aspects of the present disclosure, methods, systems, and apparatus for dynamic ocular training are disclosed. These methods, systems, and apparatus can include steps or components for: performing an eye position calibration technique in a virtual reality environment to produce a diagnosis result for a patient; selecting a virtual reality therapeutic game among a plurality of therapeutic games based on the diagnosis result; performing the virtual reality therapeutic game to receive a patient input in the virtual reality therapeutic game; dynamically adjust a difficulty level of the virtual reality therapeutic game based on the patient input; and transmitting a game result to a device associated with a therapist, the device remote from the therapeutic system, based on the difficulty level of the virtual reality therapeutic game and the patient input.

These and other aspects of the disclosure will become more fully understood upon a review of the drawings and the detailed description, which follows. Other aspects, features, and embodiments of the present disclosure will become apparent to those skilled in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. Similarly, while example embodiments may be discussed below as devices, systems, or methods embodiments it should be understood that such example embodiments can be implemented in various devices, systems, and methods.

### BRIEF DESCRIPTION OF THE DRAWINGS

FIG. 1 is a block diagram conceptually illustrating a system for therapeutic games according to some embodiments.

FIG. 2 is a flow diagram illustrating an example process for disorder treatment using a therapeutic game according to some embodiments.

FIG. 3 is a flow diagram illustrating another example process for disorder treatment using a therapeutic game according to some embodiments.

FIG. 4 is an example random-dot stereogram according to some embodiments.

FIGS. 5A-5C, 6A-6D, and 7-11 are example virtual reality therapeutic games according to some embodiments.

FIGS. 12A-12D are an example software architecture for virtual reality therapeutic game(s) according to some embodiments.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts and embodiments described herein may be implemented and practiced without these specific details. In some instances, well-known structures and components are shown in block diagram form to avoid obscuring such concepts.

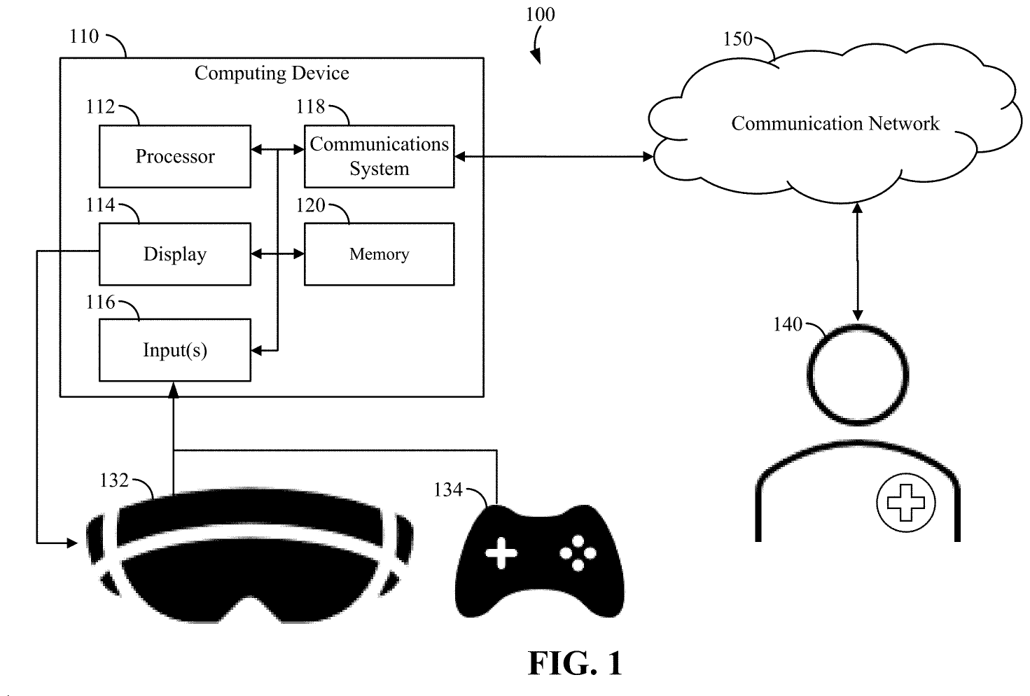

FIG. 1 shows a block diagram conceptually illustrating a system for therapeutic games according to some embodiments. As shown in FIG. 1, computing device 110 can create a virtual reality environment using a virtual reality device 132 (e.g., virtual reality headset) and provide a virtual reality therapeutic game based on a diagnosis result (e.g., from a measurement user input (e.g., using a user input device 134) or a therapist system 140). The virtual reality therapeutic game trains gaze shifts of the user, vestibular-ocular reflex (VOR), head motion, divergence/convergence transitions during gaze shifts, and/or dynamic binocular convergence using game user inputs (e.g., using the user input device 134). In some examples, computing device 110 can transmit a game result based on the game user inputs to the therapist system 140 to indicate the status or changes of the status of the ocular disorders.

In some examples, computing device 110 can include processor 112. In some embodiments, the processor 112 can be any suitable hardware processor or combination of processors, such as a central processing unit (CPU), a graphics processing unit (GPU), an application specific integrated circuit (ASIC), a field-programmable gate array (FPGA), a digital signal processor (DSP), a microcontroller (MCU), etc.

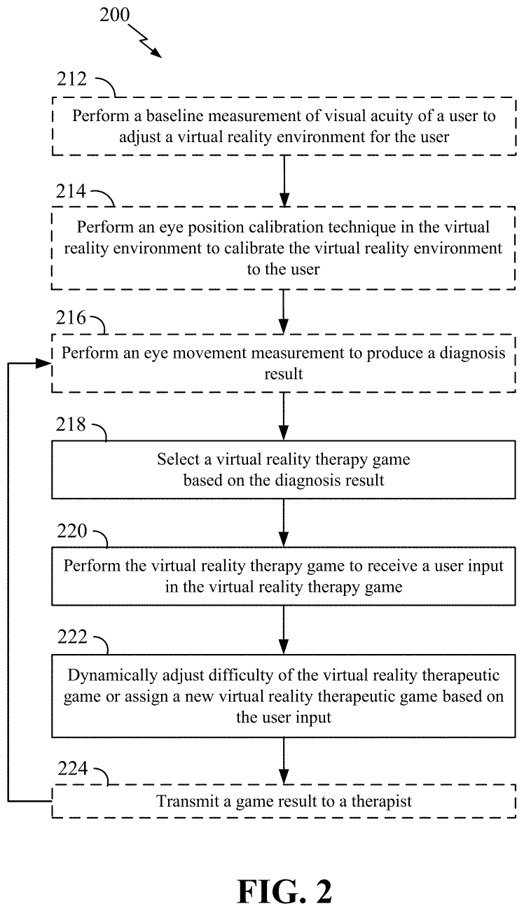

In further examples, computing device 110 can further include a memory 120. The memory 120 can include any suitable storage device or devices that can be used to store suitable data (e.g., diagnosis program, therapeutic games, etc.) and instructions that can be used, for example, by the processor 112 to generate a virtual reality environment, perform an eye position calibration technique in the virtual reality environment, perform an eye movement measurement to produce a diagnosis result, select a virtual reality therapeutic game based on the diagnosis result, perform the virtual reality therapeutic game, receive a game user input in the virtual reality therapeutic game, dynamically adjust difficulty of the virtual reality therapeutic game based on the game user input, and/or transmit a game result based on the game user input. The memory 120 can include any suitable volatile memory, non-volatile memory, storage, or any suitable combination thereof. For example, memory 120 can include random access memory (RAM), read-only memory (ROM), electronically-erasable programmable read-only memory (EEPROM), one or more flash drives, one or more hard disks, one or more solid state drives, one or more optical drives, etc. In some embodiments, the memory 120 can have encoded thereon a computer program for generating a virtual reality environment, calibrating the virtual reality environment to a user, displaying components of the therapeutic game in the virtual reality environment, etc. For example, in such embodiments, the processor 112 can execute at least a portion of the computer program to perform one or more data processing tasks described herein transmit/receive information via the communications system(s) 118, etc. As another example, the processor 112 can execute at least a portion of process 200 described below in connection with FIG. 2.

In further examples, computing device 110 can further include communications system 118. Communication system 118 can include any suitable hardware, firmware, and/or software for communicating information over communication network 140 and/or any other suitable communication networks. For example, communications system 118 can include one or more transceivers, one or more communication chips and/or chip sets, etc. In a more particular example, communications system 118 can include hardware, firmware and/or software that can be used to establish a Wi-Fi connection, a Bluetooth connection, a cellular connection, an Ethernet connection, etc.

In further examples, computing device 110 can receive or transmit information from or to the therapist system 140 over a communication network 150. In some examples, the communication network 150 can be any suitable communication network or combination of communication networks. For example, the communication network 150 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 150 can be a local area network, a wide area network, a public network (e.g., the Internet), a private or semi-private network (e.g., a corporate or university intranet), any other suitable type of network, or any suitable combination of networks. Communications links shown in FIG. 1 can each be any suitable communications link or combination of communications links, such as wired links, fiber optic links, Wi-Fi links, Bluetooth links, cellular links, etc.

In further examples, the system 100 can further include one or more sensors to track motions (e.g., of head or eyes). The one or more sensors can be included in the virtual reality device 132. For example, a sensor can include a magnetic field system with coils, an IMU, an inertial sensor, or any suitable sensor to detect head rotations and/or an eye goggle with high-speed cameras to detect the eye rotations. In some examples, the raw magnetic system data and raw eye-tracking system data can be input to computing device 110. In real-time, the sensor can calculate and steams out head and eye rotation orientation and angular velocity to computing device 110 as interactive input data. Meanwhile, computing device 110 can log all the calculated data and saves the calculated data in files for offline analysis.

In further examples, the system 100 can further include one or more user input devices 134. A user input device 134 can include a joysticks and buttons for visual interface input from patients and/or mouse and keyboard for adjusting experiment parameters and settings. For example, a patient can use the controller's joystick(s) and buttons to interact with the therapeutic game, and all those actions can be recorded for offline data analysis.

FIG. 2 is a flow diagram illustrating an example process for ocular disorder treatment using a therapeutic game according to some embodiments. As described below, a particular implementation can omit some or all illustrated features/steps, may be implemented in some embodiments in a different order, and may not require some illustrated features to implement all embodiments. In some examples, a computing device 110 in connection with FIG. 1 can be used to perform the example process 200. However, it should be appreciated that any suitable apparatus or means for carrying out the operations or features described below may perform the process 200.

Process 200 can provide preliminary diagnosis, assessment, and treatment/rehabilitation of several ocular disorders, including those relating to vestibular-reflex, vergence and near vision impairment in TBI and other conditions that affect vision. Compared to the current standard of care, process 200 and the system using process 200 can: 1) increase access to care in areas where trained clinicians and therapists are not readily available, 2) provide clinicians with more robustly quantitative measures of binocular function, 3) deliver more engaging and precisely customized exercises to patients with convergence insufficiency (CI) and near vision symptoms, and 4) provide therapists with detailed feedback regarding patients' performance and functional progress.

At step 212, process 200 can perform a baseline measurement of visual acuity of the user (e.g., each eye of the user) to adjust the virtual reality environment for the user. In some examples, process 200 can use a custom application (e.g., a custom application used in Unity for a mobile device). A tripod-supported mobile device can be set away from the user (e.g., 1 m or any suitable distance away from a tripod-supported tablet). The mobile device can display a fixation target at the center of the screen of the mobile device for the user to look at the fixation target. The target is replaced by a Landolt-C optotype in one of 8 random orientations (e.g., for 80 ms or any other suitable predetermined time period). The Landolt-C is a standardized circular letter C whose line thickness is equal to the C's gap. After this optotype is flashed, the user selects the perceived orientation using a joystick game controller. Optotype size can be varied, until the acuity threshold is determined. The size of the smallest gap that can be seen with 50% accuracy is the minimum angle of resolution (MAR). Visual acuity is then quantified by the base-10 logarithm of the MAR when it is measured in arcminutes (log MAR). An MAR of 1 arcminute (log MAR 0) is equivalent to a Snellen acuity of 20/20. The acuity is then the log MAR of that fit function that corresponds to a response accuracy of 0.5625 (halfway between 100% accuracy and the chance rate of 0.125). In some examples, the baseline measurement can describe the patient's visual ability and/or new variable gain dynamic visual acuity. In some examples, step 212 of process 200 can be optional. Thus, in the examples, process 200 can begin with step 214 without performing step 212.

At step 214, process 200 can perform an eye position calibration technique in a virtual reality environment to calibrate the virtual reality environment to a user. In some examples, eye position measurements can be used to assess convergence insufficiency (vergence impairment) and/or vestibulo-ocular reflex (vestibular impairment). In some examples, process 200 can adjust the virtual reality environment (e.g., in a virtual reality headset) to correspond to the user. Thus, the virtual reality environment is personally calibrated and customized to the user. In further examples, to perform the eye position calibration technique, process 200 can display a series of horizontal and vertical virtual target locations on the virtual reality environment to create a calibration map, detect eye positions for the series of horizontal and vertical virtual target locations, map the eye positions to the series of horizontal and vertical virtual target locations to produce a calibration scale parameter, and/or calibrate the virtual reality environment based on the calibration scale parameter. In other examples, rather than calibrating the virtual reality environment based on the calibration scale parameter, process 200 can apply the calibration scale parameter to existing data.

In further examples, the eye positions for the series of horizontal and vertical virtual target locations can include: right eye positions corresponding to the series of horizontal and vertical virtual target locations, left eye positions corresponding to the series of horizontal and vertical virtual target locations, and binocular positions corresponding to the series of horizontal and vertical virtual target locations. Thus, fixations can be acquired under multiple viewing conditions (e.g., monocular right eye, monocular left eye, and binocular). In further examples, in the eye position calibration technique, process 200 can display multiple target locations having different depths and distances from the user in the virtual reality environment. In the virtual reality environment, the user can provide user inputs to correspond to the target locations (e.g., by moving a pointer to select and reach the target locations). Based on the user inputs, process 200 can detect any discrepancies between the virtual reality environment and the user's locations and reduce the discrepancies for the virtual reality environment and the reference location (e.g., user's locations of the head, foot, head, etc.). Based on the result of the eye position calibration technique, process 200 can produce an accurate eye movement measurement result tailored to the user. In some examples, step 214 of process 200 can be optional. Thus, in the examples, process 200 can begin with step 216 or 218 without performing step 212 and/or 214. In some examples, eye position measurements can be used before playing the virtual reality therapeutic games to assess vergence impairment and/or vestibular impairment and/or after playing the virtual reality therapeutic games to assess the improvement of vergence impairment and/or vestibular impairment and assess the effectiveness of the virtual reality therapeutic games.

At step 216, process 200 can perform an eye movement measurement in the virtual reality environment to produce a diagnosis result. In some examples, the eye movement measurement can include at least one of: a vergence capacity measurement, a dynamic vergence measurement, a stereoacuity measurement, or a reading measurement. In some examples, process can perform the vergence capacity measurement by displaying a virtual target at a first distance away from two positions corresponding to eyes of the user, moving the virtual target from the first distance to a center of the two positions at a constant speed, receiving a user input when the user perceives loss of convergence for the virtual target, and producing the diagnosis result based on the user input. In some examples, process 200 can measure the objective near point of convergence (NPC) from the virtual target position at the maximum vergence angle of each trial and/or the subjective NPC (the point at which the target first appears double) is the virtual target distance when the button is pressed. Values of both measures can be averaged for the group of trials.

As a secondary measure, process 200 can also assess fatigue by looking at the change in the NPCs across the series of multiple trials (6 trials). In some examples, process 200 can repeat displaying the virtual target, moving the virtual target, and receiving a subsequence user input when the user perceives loss of convergence for the virtual target, and measure vergence fatigue based on the subsequence user input. For example, process 200 can display a virtual light source (e.g., LED light) in the virtual reality environment and move the virtual light source from a first distance (e.g., 1 m, 3 m, 5 m, 10 m, or any other suitable distance) to a second distance (e.g., 10 cm, 5.5 cm, 3 cm, 1 cm, or any other suitable distance) at variable linear speed to evoke a constant-speed change in vergence (vergence pursuit). Eye movement recording can show at what angle convergence breaks, and process 200 receives a user input when the user signals the perceived loss of convergence (onset of diplopia) by pushing a button that is recorded in the log file. In further examples, repeated testing assesses for vergence fatigue.

In further examples, process 200 can perform the dynamic vergence measurement in the virtual reality environment. For example, the participant attempts to switch fixation distance in response to vergence steps (e.g., 8, 15, and 25°), both as pure vergence, and in combination with conjugate horizontal saccades. The conjugate horizontal saccades can allow for assessment of saccade-vergence interactions. In some examples, the average step position gain (ratio of change of vergence amplitude to ideal vergence change) can be calculated for each of the three step sizes. In further examples, process 200 can determine peak vergence velocity as a function of amplitude.

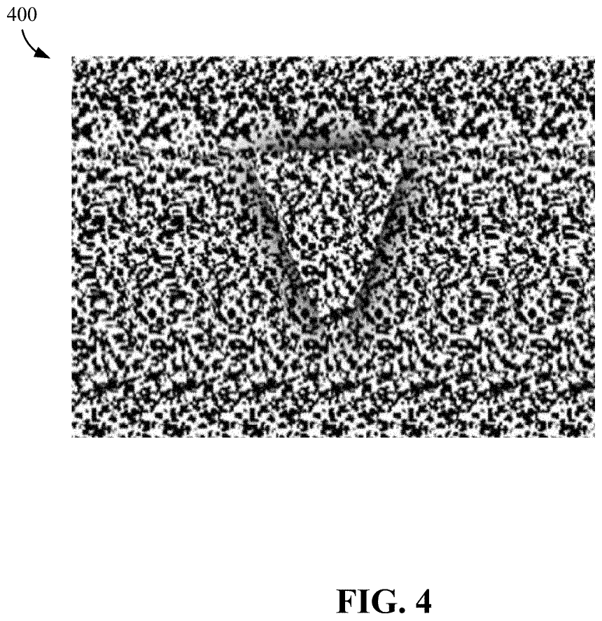

In further examples, process 200 can perform the stereoacuity measurement. For example, process 200 can display, to the user, a random-dot image 300 as shown in FIG. 4 upon which is superimposed a random-dot arrow with a different disparity than that of the background, creating a random-dot stereogram. Process 200 can receive a user input indicative of the orientation of the arrow (e.g., pointing to one of 8 directions). A series of trials with different, and randomly ordered, disparities can be presented. A sigmoidal fit of response accuracy to disparity determines the stereoacuity threshold. Stereoacuity can be tested at different virtual distances by varying the background disparity. In further examples, Stereoacuity data can include a series of data pairs representing size of stereodisparity and whether the participant's choice of arrow orientation was correct or not. These data are fit (using nonlinear least-squares optimization) to the following sigmoidal function:

$$p = 0.125 + \frac{0}{{( 1 + {e}^{{a}_{1} * ( d - {a}_{2} )} )}^{{a}_{3}}} ,$$

where p is the probability of a correct answer, d is the stereodisparity, and a₀ to a₂ are the fit parameters

In further examples, process 200 can perform the reading measurement. For example, process 200 display different levels of words at different vergence angles, receive user inputs corresponding to the words, determine a speed and an accuracy level of each of the user inputs, and produce the diagnosis result based on the speed and the accuracy level of each of the user inputs. In some examples, process 200 can adapt a reading accuracy and speed task to the virtual reality environment. Lists of common and uncommon words can be presented to the participant binocularly in the virtual reality device (e.g., virtual reality headset) at far and near virtual distances. The reading measurement (without established norms) can compare in each user the speed and accuracy or word reading at the two vergence angles. List and vergence order can be randomized to avoid an order effect. In some examples, for each word list presented in the virtual reality environment, the time to read the list and reading accuracy (percentage of words read correctly) can be determined.

In some examples, acquired reading difficulty after TBI could be due to disruption of central language processing rather than only to loss of binocular eye coordination. Process 200 can address this question by administering the reading skills and comprehension sections of an assessment test (e.g., the Wechsler Individual Assessment Test) in the virtual reality environment. In the examples, both word reading fluency and comprehension can be evaluated because reduced readability at a single word level can often deplete cognitive resources, leaving few available for attending to and comprehending what is being read.

Word Reading and Pseudoword Decoding: Users read lists of increasingly difficult words (75 total) and nonsense words (52 total), while the examiner or a computing device records errors and timing. Accuracy (number of words read correctly) and fluency (number of words read correctly within 30 seconds) are primary scores that will be converted to standardized scores (Mean=100, SD=15) using age and grade-based normative data.

Oral Reading Fluency and Reading Comprehension. Users read two passages aloud and then orally respond to comprehension questions, while the examiner or a computing device measures speed, accuracy, fluency, and prosody of contextualized oral reading. The examiner or the computing device records time to complete each of the passages (total reading rate), while also noting errors in reading (e.g., additions or mispronunciations), resulting in an oral reading accuracy score (total words read minus errors), and an oral reading fluency score (oral reading accuracy divided by the total reading rate). Raw scores are converted to standardized scores using age and grade-based normative data. In some examples, step 216 of process 200 can be optional. For example, process 200 can receive the diagnosis result from a therapist rather than perform an eye movement measurement to produce a diagnosis result. In further examples, process 200 can perform step 216 in a regular manner, on a request, or on a performance triggering event. In further examples, process 200 can perform real time assessment of head orientation, head movement, head angular velocity, eye orientation (left and right), etc. and can store these measurements for later review by patient and/or clinician.

At step 218, process 200 can select a virtual reality therapeutic game based on the diagnosis result. In some examples, process 200 may start at step 218, with the previously-described steps being optional or only utilized in initial set-up phases or at periodic assessment times. At step 218, process 200 can select a virtual reality therapeutic game among multiple virtual reality therapeutic games. In some examples, the multiple virtual reality therapeutic games train different head/eye motions of the user. For example, the different motions include at least one of: a gaze shift, a head motion, a divergence and convergence transition, or a dynamic binocular convergence. In further examples, the virtual reality therapeutic game can incorporate tasks that simulates near work or rapid changes of fixation between near and far viewing distances.

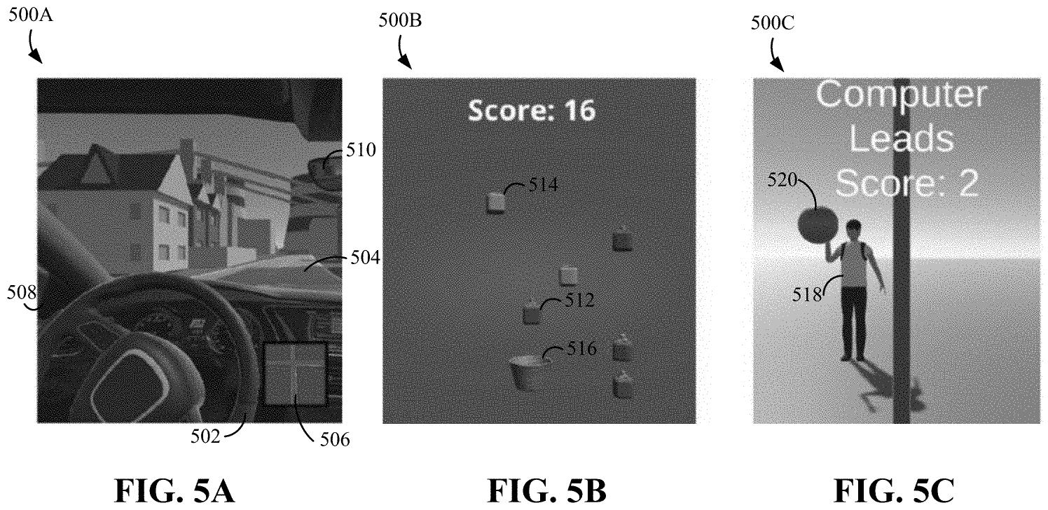

In some examples, the virtual reality therapeutic game can be a navigation-based driving game 500A shown in FIG. 5A. For example, process 200 can display a handle 502, a route roadway 504, and a navigator 506 placed closer to the route roadway 504 in the virtual reality environment, the navigator displaying a map including the route roadway, display a driving direction on the navigator. The navigation-based driving game 500A can train divergence and convergence transitions during gaze shifts. The navigation-based driving game 500A can simulate closely a key real-life task that is affected by convergence insufficiency. Process 200 provides instructions to the user to drive the car according to a route 504 that is specified on the car's navigator 506 (e.g., GPS device), avoid other cars next to, behind, or in front of the car. Process 200 additionally display other cars to be shown on a side window 508 of the car, the route 504, and/or a side mirror 512 in the car. Process 200 can train the user for the user to look back and forth between the roadway 504 (divergence—small vergence angle) and the navigation 506 (convergence—large vergence angle) quickly and accurately. The navigation-based driving game 500A can directly target a deficit—impairment of dynamic vergence. In some examples, difficulty is increased by increasing the speed of the car and increasing how close the GPS screen appears to the patient. Increasing the car's speed requires the patient to make faster gaze shifts coupled with faster transitions between binocular divergence and convergence. Increasing how close the GPS screen is to the patient increases the maximum vergence angle the user has to achieve to successfully see the map directions.

In further examples, the virtual reality therapeutic game can be a fruit basket game 500B shown in FIG. 5B. For example, process 200 can display a first object 512 with a first depth falling from a top to a bottom in the virtual reality environment and display a second object 514 with a second depth falling from the top to the bottom. The second depth of the second object 514 can be different from the first depth of the first object 512. Thus, an object in the fruit basket game 500B can fall down in a z-axis with a x-y plane in a 3D virtual reality environment. Process 200 also display a receiver 516 (e.g., a basket) configured to receive the object falling down in the receiver 516. The receiver 516 can be movable based on the game user input. In further examples, individual objects fall from the top and is desirable to be caught in the basket before the objects pass it. The virtual distance of the fruit can be adjusted to set the desired vergence angle, and the basket can be moved in and out to the depth of each fruit, in order to catch it. Via the fruit basket game 500B, process 200 can train divergence and convergence transitions during gaze shifts of the user. In some examples, difficulty is increased by increasing the how close the fruit appear to the patient, which challenges the patient to increase the maximum vergence angle of their eyes. Difficulty can also be increased by increasing the number of concurrent fruit falling and varying how close each fruit appears to the user, which challenges the user to make gaze shifts while transitioning between divergence and convergence. In addition, if the fruit have varying disparities, the game can also be made more difficult by increasing the velocity at which fruit fall, which challenges users to make faster gaze shifts while increasing the speed of transitions between divergence and convergence.

In further examples, the virtual reality therapeutic game can be a tetherball game 500C shown in FIG. 5C. The tetherball game 500C uses active vergence tracking and stereovision: the user is pitted against the computer's avatar 518 and judges the trajectory of a ball 520 in order to hit it back and score points. To determine that trajectory, the user resolve a stereo image cue. Via the tetherball game 500C, process 200 can train dynamic binocular convergence of the user. In some examples, difficulty is increased by increasing the velocity of the ball's movement and increasing how close the ball comes to the player. Increasing ball velocity challenges the user to continuously track the vergence of the ball at a faster rate. Increasing how close the ball appears to the user challenges them to increase the maximum vergence angle of their eyes.

It should be appreciated that the virtual reality therapeutic game is not limited to the listed examples in connection with FIGS. 5A-5C. For example, the virtual reality therapeutic game can be a soccer game, meteor defense game, an ice fisher game, a slicer/dicer game, or a blockbuster game. In the examples, the virtual meteor defense game can train gaze shifts of the user, the ice fisher can train gaze shifts and the vestibulo-ocular reflex (VOR) of the user, the slicer/dicer game can train precise head motion of the user, the blockbuster game can train precise head motion of the user.

At step 220, process 200 can perform the virtual reality therapeutic game to receive a game user input in the virtual reality therapeutic game. The virtual reality therapeutic game allows the user to provide a game user input in response to the therapeutic game. Referring to FIG. 5A, process 200 can receive the game user input indicative of the driving direction on the route roadway 504. For example, process 200 displays an instruction to turn right at the next intersection on the navigator 506 and display the car moving toward the intersection. On the intersection, process 200 records the game user input (e.g., using a joystick or a handle) to turn right and the time to receive the game user input. In some examples, process 200 can transmit a time of the game user input and a direction indicated from the game user input based on the route roadway and the navigator. In other examples, process 200 can determine whether the game user input correctly responds to the instruction on the navigator 506. For example, when the game user input is the right turn at the intersection (e.g., within a permissible time period), process 200 can determine that the game user input is correct. On the other hand, when the game user input is not the right turn or not at the intersection (e.g., outside of the permissible time period), process 200 can determine that the game user input results in a crash. In some examples, process 200 can count the number of crashes of the car.

Referring to FIG. 5B, process 200 can receive the game user input indicative of the movement of the basket 516 to catch the objects 512, 514 (e.g., fruit). For example, the game user input can be an up, down, right, and/or left button to move the basket 516 inward, outward, leftward, and/or rightward. Here, the up or down direction can indicate a direction in the y-axis while the left or right direction can indicate a direction in the x-axis. Then, the objects can fall down in the z-axis. Process 200 can record the game user input (e.g., up, down, left, right) using a joystick or a handle) when an object falls down to an x-y plane where the basket is located. In other examples, process 200 can determine whether the game user input correctly responds to the objects 512, 514. For example, when the game user input allows the basket 516 to receive the object 512, 514, process 200 can determine that the game user input is correct. On the other hand, when the user does not receive the object 512, 514, process 200 can determine that the game user input misses the object 512, 514. In some examples, process 200 can count the number of objects that the user missed. In other virtual reality therapeutic games, process 200 can determine whether the game user input correctly or incorrectly responds to the virtual reality therapeutic games.

At step 222, process 200 can dynamically adjust difficulty of the virtual reality therapeutic game based on the game user input. In the examples, process 200 can dynamically determine whether to increase or reduce the level of difficulty of the therapeutic game based on the game user input. Alternatively or additionally, at step 222, process 200 can dynamically assign a new therapeutic game based on the game user input. Referring to FIG. 5A, the size of the required vergence change, and hence the task's difficulty, can be modified by adjusting the virtual distance of the GPS device (the near fixation point). Difficult can be increased by increasing the speed of the car and increasing how close the navigator 506 appears to the user. Increasing the car's speed requires users to make faster gaze shifts coupled with faster transitions between binocular divergence and convergence. Increasing how close the navigator 506 is to the user increases the maximum vergence angle the user has to achieve to successfully see the map directions. In other games, difficulty can be increased by increasing speed of the game, decreasing size of characters/optotype, increasing range of head turn or gaze shift by increasing movement of objects within the game, etc. How well the user/patient performs and adapts to degrees of difficulty can then be assessed from how often the user made the ‘correct’ input or selection in the game within the allotted timeframe during the game, or how often the user identified the correct character, etc. In some embodiments, the amount of a given increase in difficulty of a game may be pre-set by a therapist treating the patient. For example, a therapist may prescribe that, once a user consistently scores at or above 90%, 95%, or 98% or consistently achieves 100% during gameplay, the degree of difficulty may be increased by a set amount such as 5%, 10%, etc. (e.g., 10% decrease in character/optotype size, 10% increase in speed or shift, etc.). The therapist may also set limits on how much the degree of difficulty may be increased before the therapist must approve further increases in difficulty. For example, if a patient has achieved consistency in a given aptitude for completing a game (e.g., performs the game a prescribed number of times for a prescribed number of days, and completes a set score consistently), process 200 may cause the device implementing the therapeutic games to send a notification to the therapist that the user may be ready for increased difficulty. At this time, the therapist may send instructions back to the device to unlock additional games, change difficulty of a game, etc.

Referring to FIG. 5B, higher levels require more sophisticated depth perception and stereovision tasks. In some examples, difficulty is increased by increasing the how close the object 512, 514 appears to the user, which challenges the user to increase the maximum vergence angle of their eyes. Difficulty can also be increased by increasing the number of concurrent objects falling and varying how close each fruit appears to the user, which challenges the user to make gaze shifts while transitioning between divergence and convergence. In addition, if the object has varying disparities, the game can also be made more difficult by increasing the velocity at which fruit fall, which challenges users to make faster gaze shifts while increasing the speed of transitions between divergence and convergence.

Referring to FIG. 5C, difficulty is increased by increasing the velocity of the ball's movement and increasing how close the ball 520 comes to the user. Increasing ball velocity challenges the user to continuously track the vergence of the ball 520 at a faster rate. Increasing how close the ball 520 appears to the user challenges the user to increase the maximum vergence angle of the eyes.

In further examples for the meteor defense game, difficulty is increased by increasing the velocity that each meteor falls toward the cities or the number of concurrent meteors that fall. By increasing these parameters, the user rotates their head faster to reload and launch more missiles.

In further examples for the ice fisher game, difficulty is increased by increasing the frequency that fish jump out of the ice. The more frequently the fish appear, the more frequently the user rotates their head to catch the fish.

In further examples for the slicer/dicer game, difficulty is increased by increasing the number of slices and the direction of slices that each piece of food is cut into. This is determined for the user to precisely control head rotation in different directions to align the head movement with the direction of each slice.

In further examples, for the blockbuster game, difficulty is increased by increasing the velocity of the bouncing ball. This is determined for the user to rotate their head faster to move the paddle and avoid missing the ball. It should be appreciated that it is not limited to the scenarios listed above to the dynamically change the difficulty of the virtual reality therapeutic game.

At step 224, process 200 can optionally transmit a game result to a therapist or a device associated with a therapist. The device can be remote from or be attached to the therapeutic system. In some examples, the game result can include the user input in response to the virtual reality therapeutic game. In other examples, the game result can include a number of correct user inputs and/or incorrect user inputs in response to the virtual reality therapeutic game. In further examples, the game result can include the level of difficulty of the therapeutic game, a time period to play the therapeutic game, a margin by which the incorrect user inputs fall short of the user input range to be correct user inputs, and/or any other suitable indications drawn from the user inputs. The therapist can include a system for the therapist. The system for the therapist receives the game result to determine the status of the user. Then the therapist can prescribe difficulty limits and/or new set of games to the user to improve ocular disorders.

In further examples, process 200 can determine improvement from having done the games, performing an eye movement measurement at step 216 and/or VOR and vergence, and/or using standard clinical measures of assessing related disorders. From the assessment, process 200 can determine which game (e.g., soccer, meteor, etc.) provide a better result plus and better results from the standard clinical assessments.

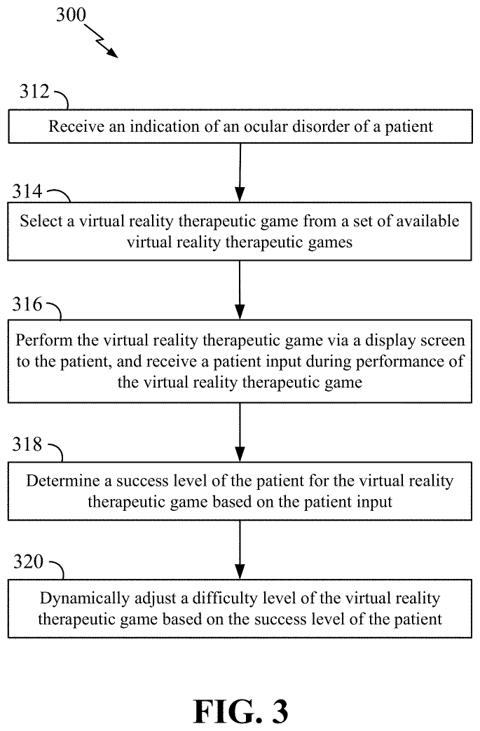

FIG. 3 is a flow diagram illustrating another example process for disorder treatment using a therapeutic game according to some embodiments. As described below, a particular implementation can omit some or all illustrated features/steps, may be implemented in some embodiments in a different order, and may not require some illustrated features to implement all embodiments. In some examples, a computing device 110 in connection with FIG. 1 can be used to perform the example process 200. However, it should be appreciated that any suitable apparatus or means for carrying out the operations or features described below may perform the process 200.

At step 312, process 300 can receive an indication of an ocular disorder of a patient. In some examples, the indication of the ocular disorder of the patient can be from a device associated with a therapist or other clinician. In other examples, process 300 can perform one or more eye measurements and produce the indication of the ocular disorder of the patient can be received. For example, process 300 can perform a vergence capacity measurement. The vergence capacity measurement can include: displaying, via the display screen, a virtual target at a first distance away from two positions corresponding to eyes of the patient, moving the virtual target from the first distance to a center of the two positions at a constant speed; receiving a measurement input when the patient perceives loss of convergence for the virtual target; and producing the indication of the ocular disorder based on the measurement input. In further examples, the vergence capacity measurement can further include: repeatedly displaying, via the display screen, the virtual target, moving the virtual target, and receiving a subsequence patient input when the patient perceives loss of convergence for the virtual target; and measuring vergence fatigue based on the subsequence patient input.

In further examples, process 300 can perform a reading measurement. The reading measurement can include: display, via the display screen, different levels of words at different vergence angles; receiving measurement inputs corresponding to the words; determining a speed and an accuracy level of each of the measurement inputs (e.g., to incorporate voice recognition); and producing the indication of the ocular disorder based on the speed and the accuracy level of each of the measurement inputs.

In further examples, process 300 can perform a virtual eye position calibration. The virtual eye position calibration includes: displaying a series of horizontal and vertical virtual target locations on the display screen to create a calibration map; detecting eye positions for the series of horizontal and vertical virtual target locations; mapping the eye positions to the series of horizontal and vertical virtual target locations to produce a calibration scale parameter; and calibrating the display screen based on the calibration scale parameter. In some examples, the eye positions for the series of horizontal and vertical virtual target locations include: right eye positions corresponding to the series of horizontal and vertical virtual target locations, left eye positions corresponding to the series of horizontal and vertical virtual target locations, and binocular positions corresponding to the series of horizontal and vertical virtual target locations.

At step 314, process 300 can select a virtual reality therapeutic game from a set of available virtual reality therapeutic games. In some examples, each of the set of available virtual reality therapeutic games is designed to provide therapy for one or more of a given set of ocular disorders. The virtual reality therapeutic game can be selected based on the indication of the ocular disorder, the selected virtual reality therapeutic game being designed to provide therapy for the ocular disorder. In further examples, process 300 can receive an updated setting from the device associated with the therapist. The virtual reality therapeutic game can be selected further based on the updated setting. In some examples, the virtual reality therapeutic game can be selected only based on the updated setting. For examples, the therapist can directly send a prescription to use a particular game for treatment. Then, process 300 can override other factors but select the virtual reality therapeutic game based on the updated setting.

At step 316, process 300 can perform the virtual reality therapeutic game via a display screen to the patient, and receive a patient input during performance of the virtual reality therapeutic game. In some examples, the virtual reality therapeutic game incorporates tasks that simulate near work or rapid changes of fixation between near and far viewing distances. In some examples, to perform the virtual reality therapeutic game, process 300 can display, via the display screen, a handle, a route roadway, and a navigator placed closer to the route roadway, the navigator displaying a map including the route roadway; display, via the display screen, a driving map direction on the navigator; and receive the patient input indicative of a driving vehicle direction on the route roadway.

In other examples, to perform the virtual reality therapeutic game, process 300 can display, via the display screen, a first object with a first depth falling from a top to a bottom; display, via the display screen, a second object with a second depth falling from the top to the bottom, the second depth being different from the first depth; and receive the patient input to catch the first object and the second object.

At step 318, process 300 can determine a success level of the patient for the virtual reality therapeutic game based on the patient input. In some examples, the success level increases in response to the driving vehicle direction being equal to the driving map direction. In other examples, the success level increases in response to the patient input catches the first object and the second object.

At step 320 process 300 can dynamically adjust a difficulty level of the virtual reality therapeutic game based on the success level of the patient. In some examples, to dynamically adjust the difficulty level of the virtual reality therapeutic game, process 300 can: automatically increase or decrease the difficulty level based on the success level compared to one or more previous success levels of the patient. The one or more previous success levels can be determined based on previous patient inputs. In further examples, the difficulty level of the virtual reality therapeutic game is adjusted further based on a therapist input of a therapist. The therapist input comprises an updated difficulty level of the difficulty level.

In further examples, process 300 can further automatically select another virtual reality therapeutic game. Another virtual reality therapeutic game can be different from the virtual reality therapeutic game and be designed to provide therapy for the ocular disorder.

In even further examples, process 300 can automatically transmit a notification to the therapist based on the success level of the patient. In further examples, process 300 can automatically transmit a notification to the therapist when a difference between the success level of the patient and the previous success level(s) is more than a predetermined level.

In further examples, an example virtual reality therapeutic game can be used for vestibular rehabilitation. A person's vestibular system measures head motion and drives the reflexes that are critical for maintaining vision and balance during movement. A normal vestibulo-ocular reflex (VOR) fully compensates for head rotation by moving the eyes in the opposite direction so that the world appears still. If the VOR is impaired, the eyes do not counter-rotate properly, and the world moves on the retinas, causing oscillopsia. Vestibular damage is common and is caused by a variety of inner ear and neurological conditions. Clinical disorders of vestibular function may include unilateral vestibular hypofunction (which may be caused by vestibular neuritis), bilateral vestibular hypofunction (which may be degenerative or caused by ototoxicity), central vestibular disorders such as cerebellar disease, and altered vestibular perception. Loss of vestibular function causes substantial functional disability in many cases, due to loss of gaze stability and impaired postural control. Because there is no effective medication to restore vestibular function once it has been lost, treatment is generally performed via vestibular rehabilitation therapies. Conventional vestibular therapy programs generally include gaze stability exercises to improve vision during head movement and balance exercises to restore good postural control. However, the standard clinical gaze-stability exercises are relatively primitive, such as having a subject turn their head while looking at a spot on a wall. It is generally difficult to customize such standard exercises to a particular subject's degree of vestibular loss.

A method of using computer virtual environments (e.g., virtual reality environments) may deliver customized vestibular exercises to patients with impaired vestibular function who need training to improve their visual stability during head movement. Such exercises may be performed by a subject (i.e., a person having impaired vestibular function) in connection with an interactive game executed by an interactive game system, which may be, for example, a computer system. The interactive game may be controlled by the patient's head movements (e.g., which may be detected by hardware and/or software of the interactive game system). The interactive game may involve completion of tasks by the subject, which may involve the interactive game system requiring the subject to achieve steady visual fixation on a virtual object in order for the subject to successfully complete a given task. For example, by manipulating the relationship between the observed visual virtual scene and the subject's head movement, the interactive game system may match the therapy to that subject's specific level of vestibular function impairment.

As therapy via the interactive game progresses, the interactive game system may advance the difficulty of the interactive game. The subject's performance in the interactive game is a measure of therapeutic gains and the basis for advancing difficulty of exercises presented to the subject in the interactive game. The subject's performance in the interactive game may be stored in a memory device included in or communicatively coupled to the interactive game system. For example, the interactive game system may automatically log information corresponding to aspects of the subject's performance in the interactive game (i.e., subject performance information) Examples of such information may include but are not limited to: scores achieved by the subject, accuracy with which the subject performs the exercise, recorded video of the virtual scene during gameplay by the subject, the head and eye rotation speed of the subject, the subject's VOR gain at different distances, visual acuity when the subject's head is moving and when the subject's head is still, and other similar information. A subject's doctor or therapist may access the subject's performance information, based on which the doctor or therapist may ascertain the subject's adherence to the prescribed therapy, whether exercises are being performed correctly by the subject, and how the subject's performance is changing over time. The subject may also be asked to answer a questionnaire after each game, rating subjective effects such as sensations of vertigo or other discomfort, and the related data stored and utilized to tailor future instances of the game being played by the subject.

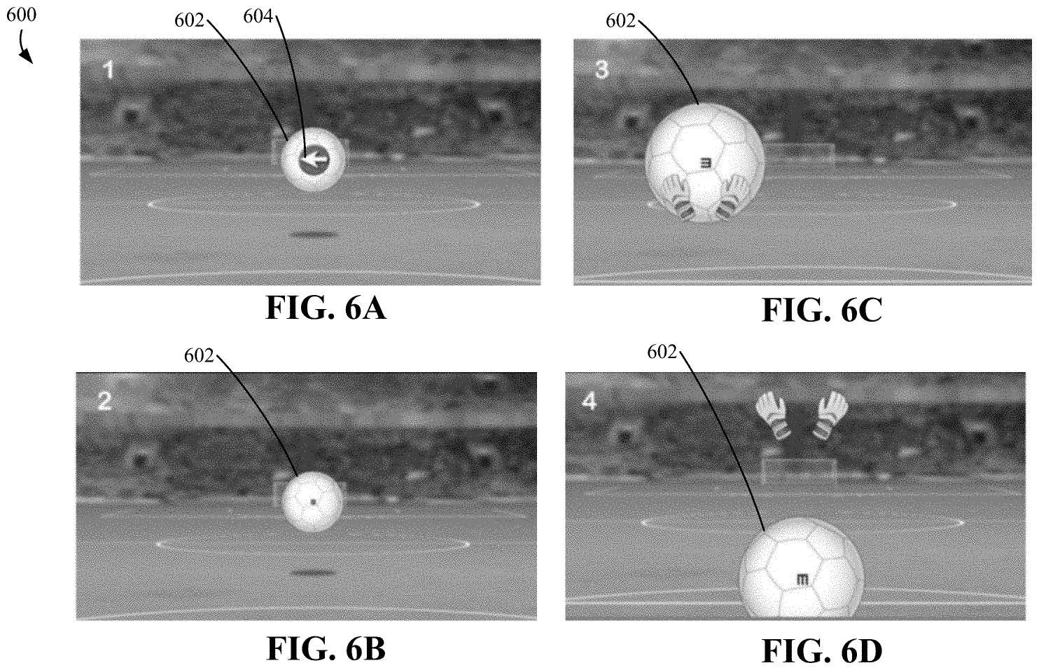

In an example scenario, the interactive game may provide the subject with a soccer-related simulation from the perspective of a goalie facing a penalty kick, as seen in Example 1. The subject's task as the goalie is to determine the direction in which a virtual ball will travel toward the goal (e.g., up, down, left, right and diagonal directions), in order to “catch” the virtual ball to prevent a goal from being scored. For each simulated penalty kick, the interactive game system 600 may generate a symbol depicted on a surface of the virtual ball 602, as seen in Example 1, FIG. 6A. The direction 604 in which the virtual ball 602 will travel is indicated by the orientation of the symbol as it appears on the virtual ball. The symbol may only be displayed on the virtual ball 602 in response to the system determining that the subject's head is moving (e.g., the symbol may only appear if the rotation speed of the subject's head is greater than a predetermined threshold, such as around 100 degrees per second, and the symbol may be displayed for a predefined time period such as around 100 ms). Thus, the subject must track the ball 602 while moving their head in order to perform the task accurately.

The subject may press a controller button corresponding to the direction in which he/she thinks the virtual ball is moving according to the orientation of the symbol. If the subject presses the correct button, corresponding to the virtual ball's actual movement, then the task is successfully completed (e.g., a “goal” is prevented), as seen in Example 1, FIG. 6C. If the subject presses an incorrect button, corresponding to a direction other than that in which the virtual ball 602 is moving, as seen in the comparison between Example 1, FIG. 6B and Example 1, FIG. 6D, the task is considered by the system to have been failed by the subject and a goal is scored, as seen in Example 1, FIG. 6D.

As the subject successfully completes the task, the difficulty of the task may be increased by the system (or, in some embodiments, by an administrator of the system, which may be the therapist of the subject). For example, to increase the difficulty, the distance of the ball from the subject, as perceived by the subject, may be adjusted, or the size of the symbol may be reduced. As another example, the difficulty may be adjusted to the subject's ability by changing the ratio of the speed with which the virtual reality scene moves to the speed with which the subject's head moves. As another example, the difficulty may be adjusted by increasing the minimum threshold speed with which the subject is required to move his/her head in order for the symbol to be displayed. For example, difficulty is set to the patient's (e.g., player's) baseline ability (VOR gain), which will move the entire game scene in the same direction with respect to the player's head rotation so their eyes do not need to counter rotate as fast as their head. The game's difficulty is increased by decreasing the rate at which the game scene moves in the same direction with respect to the direction of the player's head rotation. This requires the player's eyes to counter rotate at a faster speed that will more closely match the player's head rotation.

The interactive game system may include an immersive (e.g., virtual reality) or non-immersive computer display. The interactive game system may include a portable motion tracker that measures and tracks the movement of the subject's head during gameplay, examples of which include but are not limited to a head-mounted inertial measurement unit (IMU), a 6 Degree Of Freedom (6DOF) motion tracking system (for example one made by Polhemus), or other similar devices. For embodiments in which the interactive game system includes a headset (e.g., a head-worn immersive visual display) worn by the subject during gameplay, the headset may include inertial sensors that may measure and track the movement of the subject's head during gameplay.

The interactive game system may identify an individual subject's level of vestibular impairment, and may customize the difficulty of the interactive game based on the identified level of vestibular impairment, which may enhance effectiveness of the therapy by avoiding presenting the subject with tasks/exercises that are too difficult or too easy for them. The interactive game system may assess functional improvement of a subject and perform corresponding increases in difficulty level of tasks/exercises presented to the subject, as indicated above, thereby performing automated progression of the subject's rehabilitation. The interactive game system may perform real-time recording of gameplay and logging of other performance data, which may provide direct and quantitative measures of the subject's compliance with therapy and the subject's performance on games, as indicated above.

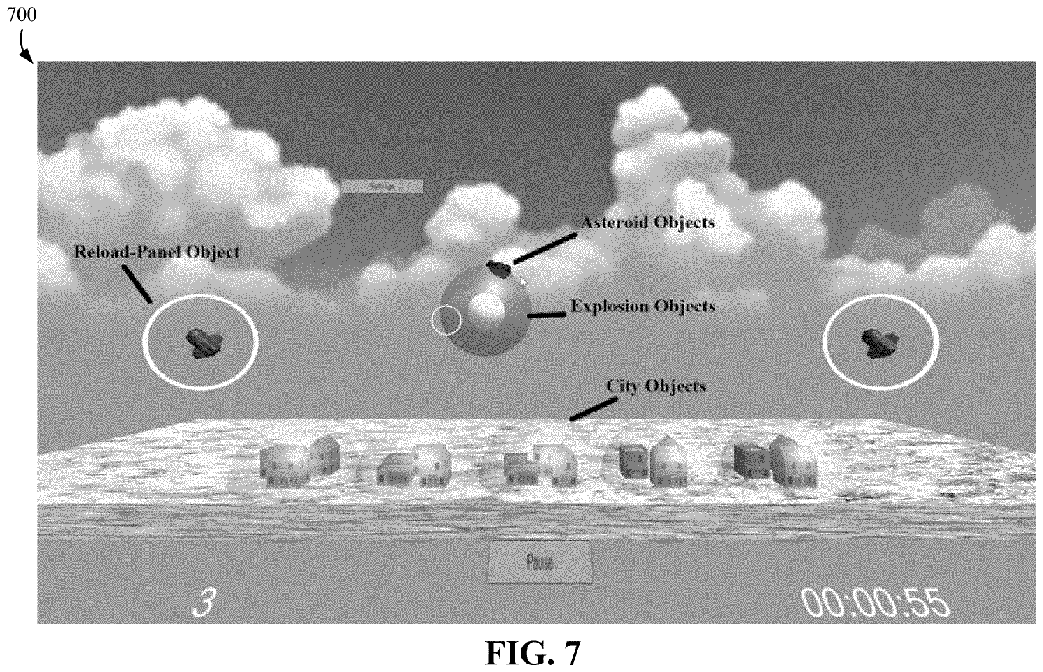

In further examples, other virtual reality therapeutic games are available. In some examples as shown in FIG. 7, a meteor defense game 700 can be used. The premise of this game is to defend the cities from falling meteors. The patient or participant needs to turn their head back-and-forth between the reload panel and the meteors trials: each hit to the reload panel only gives the participant one chance to fire. The game aims to let the participant practice these fast and accurate large-angle multi-point gaze-shifts, which trigger repeated activation of the VOR.

The Meteor Game Objects System is the primary system to present the game and is controlled directly by the Game Controller. It can contain four sub-systems: Meteor Objects, City Objects, Explosion Objects, Reload-panel Objects. The Meteor Objects can be instantiated by the Game Controller and move toward the City Objects. It either is destroyed by colliding with the City Objects or with the Explosion Objects. The City Objects are instantiated at the start of each level. Each of them contains a variable “health,” which would decrease when the Meteor Objects hit the City Objects. When the “health” goes to zero, the City Object is destroyed. The Explosion Object is instantiated when the Trigger Button is pressed (if already reloaded). The Explosion position is controlled by the Ray Cast from the Head Simulator that was discussed earlier in this section. Thus, the patients or participants are able to use their head as the cursor to control the Explosion Object's position. The Reload-panel Objects are fixed on the side of the scene. Patients or participants need to use their head to point to the panel, then press the Trigger Button to activate the reload action. Each reload action allows the participants to spawn one Explosion Object. That is why participants need to switch between the reload panel and the Meteors' trials quickly to play the game. In some examples, difficulty of the virtual reality therapeutic game can be dynamically adjusted based on the user input. For example, difficulty is increased by increasing the velocity that each meteor falls toward the cities or the number of concurrent meteors that fall. By increasing these parameters, the user must rotate their head faster to reload and launch more missiles.

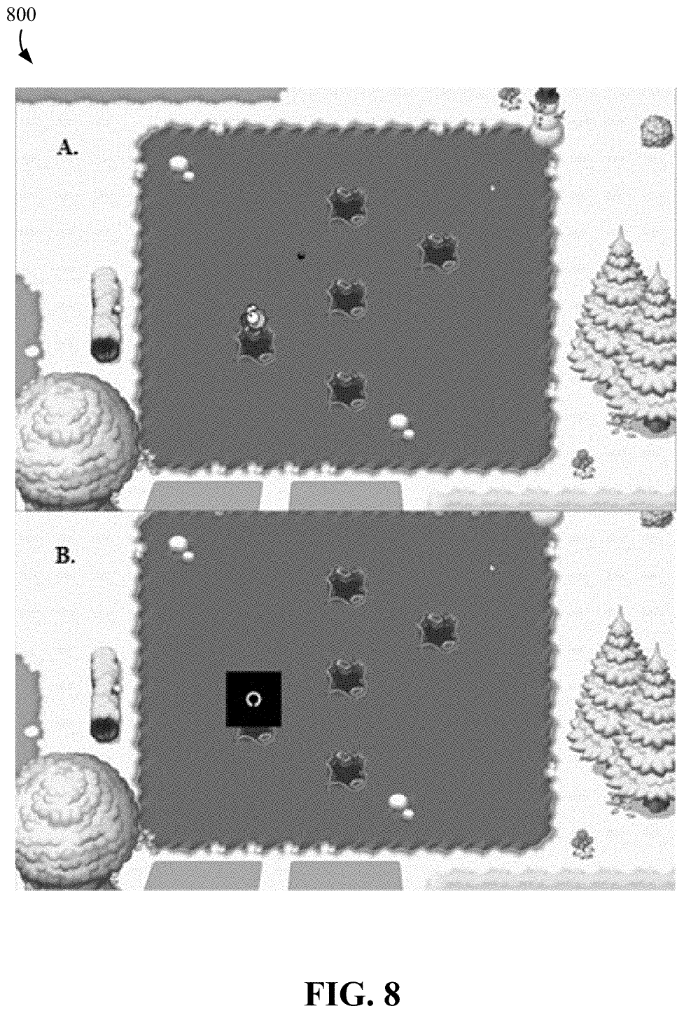

In further examples as shown in FIG. 8, an ice fisher game 800 can be used. The scenario here is a fish catching game. The patients or participants need to use their head to aim at the fish when they jump up from the lake and resolve the optotype that appears on the fish correctly to catch the fish. This game 800 also use patients or participants to practice multi-points gaze-shift. However, compared to the Meteor Defense, this game focuses on the challenge of resolving optotypes rather than head rotation accuracy.

Ice Fisher Game Objects System: The Game Objects System is the primary system to present the game 800. There are three sub-systems in this system: Hole Objects, Fish Objects, and Optotype Objects. The Hole Objects can be instantiated at the start of each level. They represent the potential position that the Fish Objects would spawn. The Fish Objects are frequently instantiated by the Game Controller, and the position is randomly chosen from all the Hole Objects that already existed. When participants use their head to aim at the fish, an optotype props up for 80 ms, and participants successfully catch the fish if they resolve the optotype correctly. In some examples, difficulty of the virtual reality therapeutic game can be dynamically adjusted based on the user input. For example, difficulty is increased by increasing the frequency that fish jump out of the ice. The more frequently the fish appear, the more frequently the user must rotate their head to catch the fish.

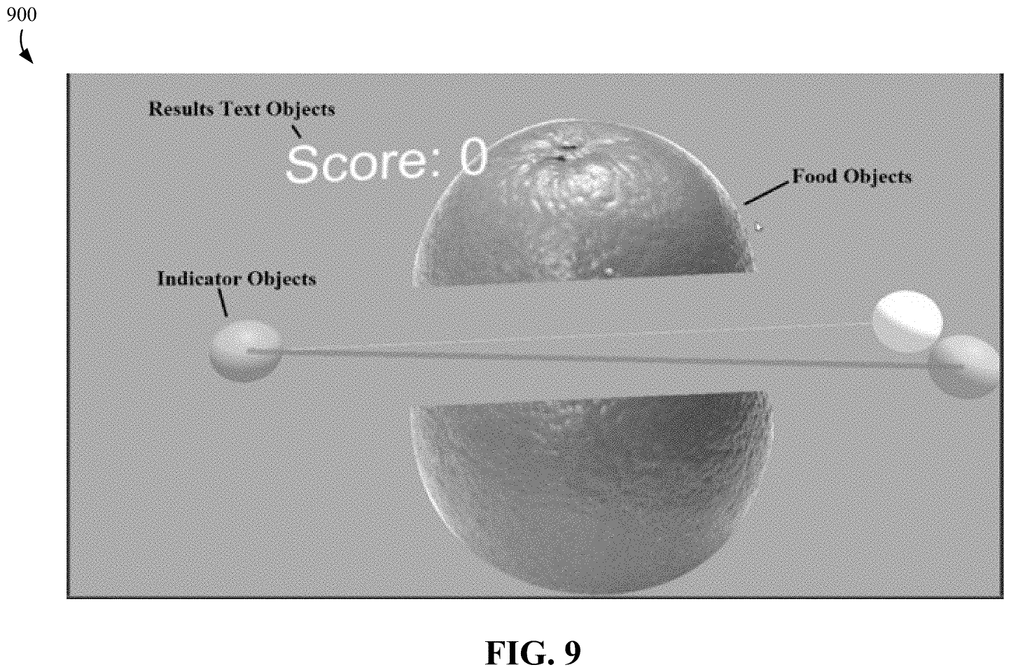

In further examples as shown in FIG. 9, a slicer/dicer game 900 can be used. The scenario of the game 900 is to allow the patients or participants to slice the food with their head rotation. It requires patients or participants to practice precise control of head turn trajectory and velocity while conducting a natural head rotation and gaze-shift. The patients or participants are instructed to rotate their heads from one point to another to finish a cut trial. The cutting trajectory is then recorded and compared to the ideal trajectory, and any difference reduces the bonus score, which is calculated later. After finishing all the cutting trials, the program can compare the shape of each piece to the ideal shape and also deduct the bonus score for differences. The total bonus score is then converted into stars, and feedback is given to the participants about how well they did. The stars can also be used to unlock levels with higher difficulty. In some examples, difficulty of the virtual reality therapeutic game can be dynamically adjusted based on the user input. For example, difficulty is increased by increasing the number of slices and the direction of slices that each piece of food must be cut into. This requires users to precisely control head rotation in different directions to align their head movement with the direction of each slice.

Slicer/Dicer Game Objects System: The Game Objects System is the primary system to present the game. There are four sub-systems in this system: Food Objects, Indicator Objects, Results Text Objects, and Menu Panel Objects. The Food Objects are instantiated at the start of each level. They visually provide a scenario of what the participants are about to cut. The Food Objects are separated into multiple pieces after the slice action. The Indicator Objects inform the participants where to aim their head and which direction to slice the food. It is also instantiated at the start of each level. Results Text Objects are texts that inform the participants of how well they have done fo that level. It gives accurate feedback and helps the participants to improve. The Menu Panel Objects is presented at the start of the game. Participants use these panels to choose which level to play.

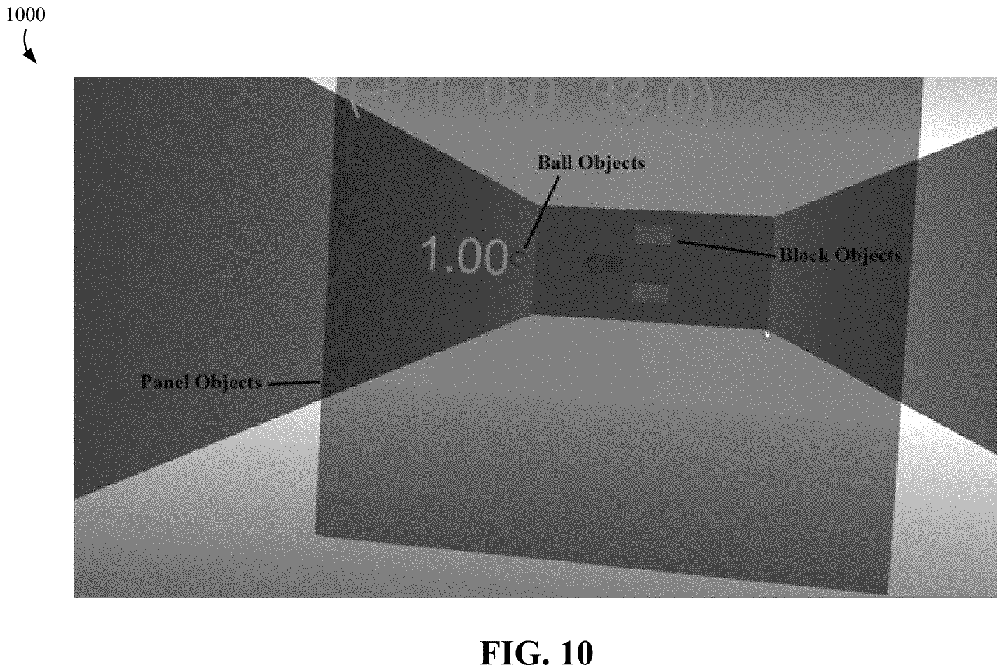

In further examples as shown in FIG. 10, a blockbuster game 1000 can be used. The Blockbuster originated from a classic game “Breakout.” The participants need to use the head rotation to control a panel to catch a ball, so the ball bounces back and hits/destroys the blocks in the scene. This game requires participants to practice functional integration of head and eye coordination, point-to-point gaze-shifts as well as real-time target tracing gaze movements. In some examples, difficulty of the virtual reality therapeutic game can be dynamically adjusted based on the user input. For example, difficulty is increased by increasing the velocity of the bouncing ball. This requires users to rotate their head faster to move the paddle and avoid missing the ball.

Blockbuster Game Objects System: The Game Objects System is the primary system to present the game. There are three sub-systems in this system, which were: Panel Objects, Ball Objects, Block Objects. One of the Panel Objects is instantiated at the start of each level. This object's position is controlled by participants' head rotation through the Head Simulator and Ray Cast Components. It inherits the Unity physics, which lets the Ball Objects bounce back without losing velocity. One of the Ball Objects is also instantiated at the start of each level. It also inherits the Unity physics so it can interact with the Block Objects and Panel Objects. It triggers the fail-action (loss score) and re-spawns if the participants fail to catch the ball with the panel. Block Objects are instantiated continuously in a certain period during the game. If hit by the Ball Objects, they would despair and add trigger bonus-action (add score). They may also move in the Game to increase the difficulty. In some examples, difficulty of the virtual reality therapeutic game can be dynamically adjusted based on the user input.

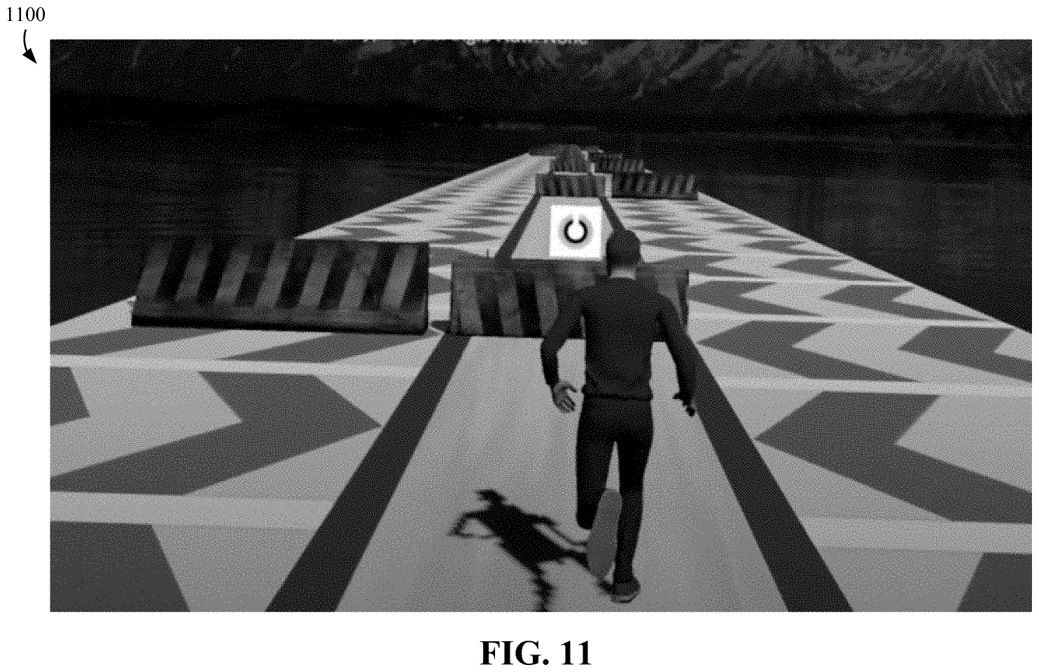

In further examples as shown in FIG. 11, an endless-runner game 1100 can be used. The goal of this endless-runner game is to steer the main character away from oncoming obstacles, which is achieved by the patient rotating the head toward the lane that they want the main character to move toward. In the VOR Training Mode, an optotype can briefly appear over the main character's head while the player's head is turning. If the player inputs the correct optotype orientation, the main character will shift lanes to avoid the obstacle—otherwise the main character keeps running in the same lane and will stumble over an obstacle. In the Vergence Training Mode, a random stereo dot image can be presented to the player that contains a symbol representing the safe lane that next set of obstacles will not appear in. After the stereo dot image disappears, the patient can rotate it head toward the direction of the safe lane to steer the main character away from oncoming obstacles. In the third VOR+Vergence training mode, the patient is instructed to identify the safe lane from a stereo dot image (s in the Vergence Training Mode), but while the patient rotates the head to steer the main character into the safe lane, an optotype will briefly appear over the main character's head (as in the VOR training mode) that the player must respond correctly to in order for the main character to shift lanes.

In all training modes, difficulty is increased by increasing the rate at which obstacles approach the main character, which reduces the rest period that the patient has between having to avoid obstacles. In the VOR Training Mode, increasing the minimum head rotation velocity threshold that triggers the optotype to be displayed also increases difficulty by requiring the patient to rotate the head faster. In the Vergence Training Mode, the stereo dot's vergence angle can be increased to require participants to verge objects that appear closer to the eyes. The same difficulty adjustments can be applied to the VOR+Vergence Training Mode.

### Example 1: Desktop/Laptop Implementation

In one embodiment, a system may be implemented via a computer and a motion tracking apparatus. In some embodiments, the system may be an IMU, camera-based, magnetic-based, or based on similar technologies. A user with an impairment will be instructed to view the screen. During runtime of the software, the user will view an object of interest on the screen, such as a soccer ball. The user will then be instructed to turn his/her head, e.g., to the left or to the right. The user's movement will be detected by the motion tracking apparatus. As the user's head is turning, a directional symbol will be displayed in association with the object of interest on the screen. Optionally, the system may be programmed such that feedback from the motion tracking apparatus is used to “gate” when the direction symbol is being displayed—i.e., the symbol is displayed only when it is detected that the user's head is rotationally turning the proper direction and/or at the proper rate. The size of the symbol, the “forgiveness” of how it is gated to head motion, and the rate at which the user is instructed to turn his/her head may be customized to the user's particular impairment. After the user has finished turning his/her head, he/she will be asked to guess what direction the directional symbol had been indicating during head movement. If the user answers correctly, he/she “wins” the rehabilitation “game”.

The “wins”, and optionally also the losses, are tracked in a profile for the individual user. Other information that may be included in the profile may include: measurements of the speed and fluidity of the user's head turning, survey feedback provided by the user (e.g., “Did turning your head that fast cause you to feel nauseous?”), number of repetitions, time and duration of use by the user, how challenging the game was for the user, how fun the game was for the user, and/or any bugs/malfunctions experienced by the user. From this profile, a rehabilitation regimen can be determined. For example, if a user routinely “wins” the exercises, exhibits good head motion, and reports no nausea, then the application can automatically (or per instruction of a therapist) make the next exercises more difficult (e.g., by decreasing the size of the directional indicator, requiring faster head turning, etc.). Some measures that may be used to determine whether a subject is ready to move to more challenging exercises may include by are not limited to: in-game acuity, ability to maintain positive despite decreases in the size of the optotype, ability to maintain a positive score despite increases in the VOR, ability to maintain a positive score despite increases in the VOR and decreases in the optotype, and/or other similar measures. Adjustments to the difficulty of exercises may be made based on recent prior attempts/games by the user, for example the last 10 attempts/games.

### Example 1: VR Implementation

In another embodiment, the user may be asked to wear a virtual reality headset. The display of the headset may present an object of interest similarly to the example set forth above. And, built in rate sensors and IMUs of the device may be utilized for head motion tracking. Optionally, such a system may be configured to “assist” a user by slightly moving the viewed scene in registration with the user's head motion. For example, if a user turns his or her head at a certain rotational speed in one direction, the scene displayed in the headset may automatically track or “slide” along with the user's rotation, at the same, a slightly lesser, or substantially lesser rate. Alternatively, the object of interest (e.g., the soccer ball) could slide across the scene/background as though it were moving relative to the background, in registration with head movement.

### Example 2: Varying Visual Distances

In another embodiment, the display of the headset may present an object of interest similarly to the examples set forth above, but at different varying visual distances. In some embodiments, the subject may be required to track objects at alternating visual distances from the perspective of the subject. In some embodiments, the subject may be required to track objects that change their visual distances from the perspective of the subject.

### Example 3: Rapid Movements

In another embodiment, the display of the headset may present an object of interest similarly to the examples set forth above, but the object or objects may be aligned or may move such that the user is required to make more precise rapid head rotations so the eyes are better aimed toward the visual target and compensate for any residual VOR impairment that cannot be adapted.

### Example 4: Dynamic Visual Acuity

In another embodiment, the display of the headset may present an object of interest similarly to the examples set forth above, but the object or objects may be aligned or may move such that the system may access the subject's dynamic visual acuity.

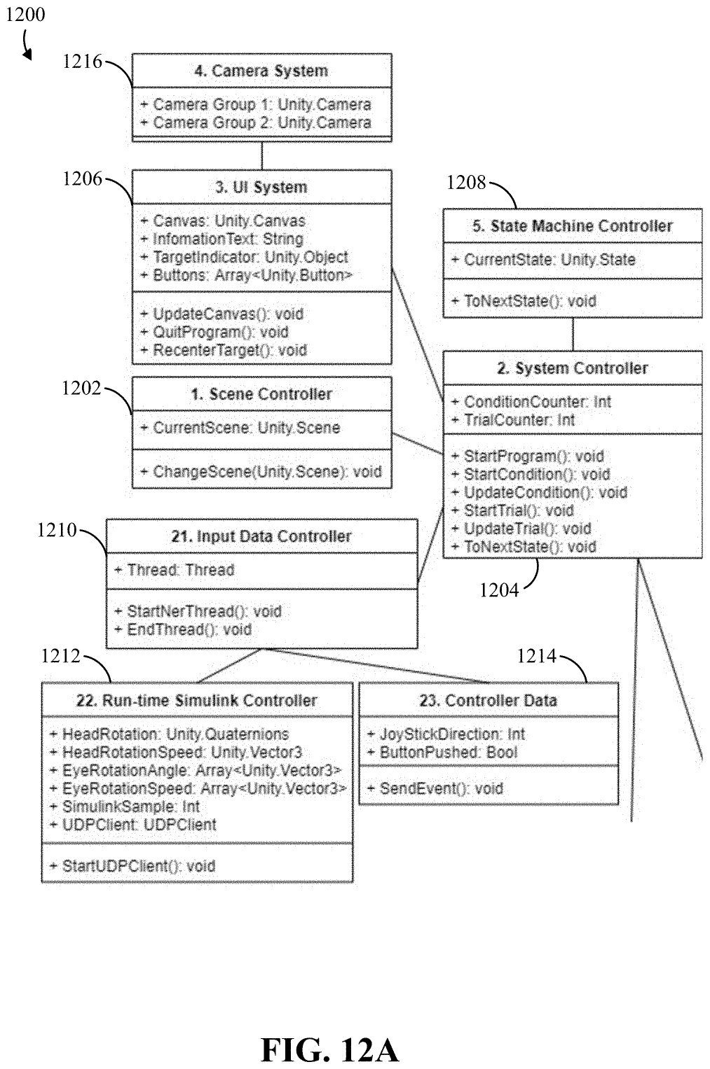

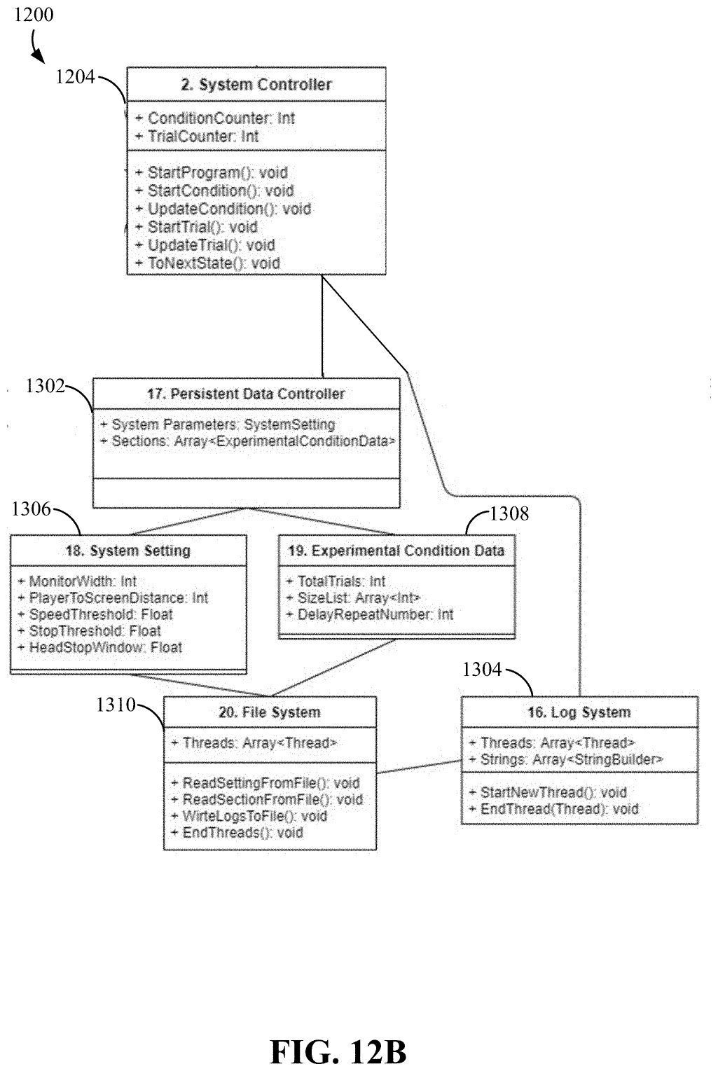

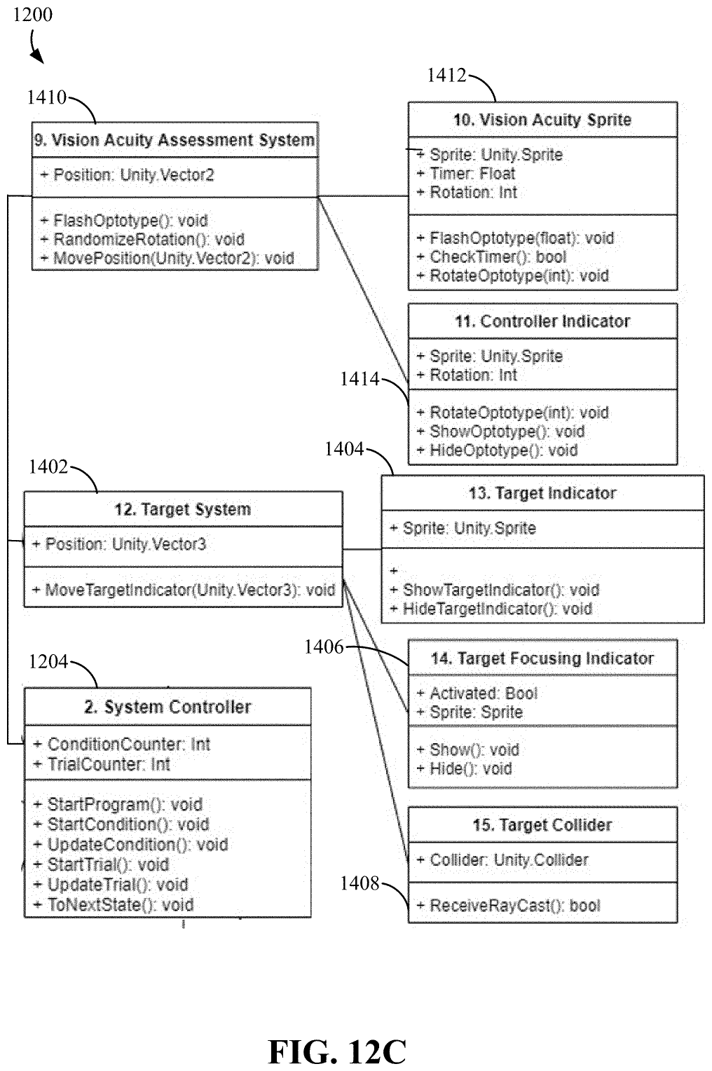

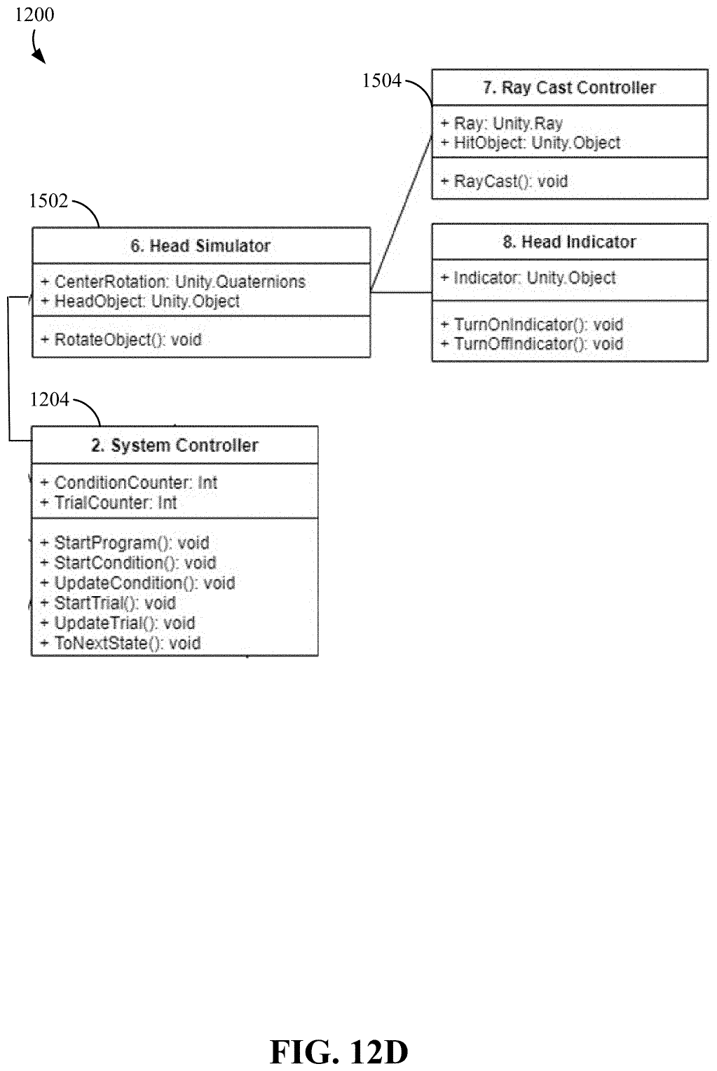

FIGS. 12A-12D are an example software architecture for virtual reality therapeutic game(s) according to some embodiments. Each block of the software architecture 700 represents a single component in the program, and the title (first entry for each block) represents the name of the component. The second entry represents the variables that existed in that component, and the third entry includes all the functions that are developed in this component. If a line connects two components in the figure, those two components are able to interact with each other, such as exchange data or sending and receiving events. In some examples, the Scene Controller 1202 (object #1) is used to control the program overall. Initially, the Scene Controller 1202 leads patients (e.g., users, participants, etc.) into an assessment scene where most of the data collection occurred.

System Controller 1204: Once in the assessment scene, System Controller 1204 (object #2) can be the central controller of the whole program. System Controller 1204 sends and receives events with most of the other components directly or indirectly. System Controller 2204 interacts with UI System 1206 (object #3) to check whether the button had been clicked and respond by interacting with other components. Also, System Controller 1204 interacts with State Machine Controller 1208 (object #5) and operates the corresponding function based on the state. With the logical code developed with the variable condition counter and trial counter, the program decides which assessment it should run and further sends out events to Vision Acuity System 1410 (object #9 in FIG. 12C) about the acuity size and display time, as well as to Target System 1402 (object #12 in FIG. 12C) about what position it should be moved to. Those data are received from Persistent Data Controller 1302 (object #17 in FIG. 12B). In some examples, all the events are sent into this component from Input Data Controller 1210 (object #21) and logged with Log System 1304 (object #16 in FIG. 12B).

System Controller 1204 can be also in charge of deciding whether a head turn was valid when the head turn was used in the assessment. To achieve this, three parameters are gathered from System Setting 1306 (object #18 in FIG. 12B) through Persistent Data Controller 1302, which are “Speed Threshold,” “Stop Threshold,” and “Head Stop Window.” When the program was waiting for the patients to turn their heads, it monitors the head speed and head rotation angle from Run-time Simulink Controller 1212 (object #22) through Input Data Controller 1210. Once the absolute horizontal head speed exceeds the Speed Threshold, it can be determined a valid head turn. On the other side, if the horizontal head rotation angle reaches a threshold but the speed was not fast enough, this head turn might not be valid, and further actions are conducted based on the experimental condition. After the valid judgment, the program continues to monitor the head speed until it is lower than another speed threshold (Stop Threshold). If the speed is lower than the threshold for a certain amount of time (Head Stop Window), it decides the head was completely stopped. The rationale for this is that most people have subtle head movements just before they completely stop their heads. Those head movements can be recorded for offline analysis.

State Machine Controller 1208: State Machine Controller 1208 (object #5) can control all state flows of the whole program. The “Current State” variable stores the information of the state index and how this component should interact with System Controller 1204 in the current state, as well as what the next state will be. It is driven by an Animator Controller, where the states are connected by arrows and conditions judged by the code in the state behavior files attached to the state blocks. Once a new state is entered, it requests System Controller 1204 for the parameters for this state and sends back events to System Controller 1204 about what to do. If a “to next state” signal is received from System Controller 1204, it finishes the current state and jumps to the next state.

Persistent Data Controller 1302: Persistent Data Controller 1302 (object #17 in FIG. 12B) can store all the variables that are used in the complete assessment. Before System Controller 1204 could make any decisions, the data from System Setting 1306 (object #18) variables and Experimental Condition Data 1308 (object #19) are used, which is stored in Persistent Data Controller 1302 and read from File System 1310 (object #20). Since multiple assessments can exist in a single run, multiple assessments' data can be stored in an array, and the index represented the assessment order.

File System 1310: File System 1310 (object #20) can be implemented for reading and writing data from and into files on hard drives. System Settings 1306 (object #18) parameters can be stored (e.g., in a JSON file), and deserialize to a run-time class when the program starts, and these data can be manually gathered and typed (e.g., into the JSON file) before the program starts. System Settings 1306 can contain MonitorWidth: Width of the display monitor in centimeters, PlayerToScreenDistance: Distance between a participant and the monitor in centimeters, SpeedThreshold: The angular speed to pass the head-turning threshold in degrees per second, StopThreshold: The angular speed to judge whether the head stopped in degrees per second, HeadStopWindow: The time window that judged whether the head stopped completely in seconds.

Additionally, Experimental Condition Data 1308 (object #19) parameters can be stored (e.g., in a Text file) and read by the program line by line. The parameters can include: TotalTrials: Total trial number for this assessment; SizeList: A list to contain the optotype size indexes (see Section 3.1.2) information with order; DelayRepeatNumber: Repeat times for each delay period.

File System 1310 can handle all the reading and writing events. Before the program ends, it interacts with Log System 1304 (object #16) and writes all the log strings to Text files. Since writing the large arrays that contain head motion data to the hard drive would cause unwanted halts in the program, multiple threads are created to achieve these tasks. For each task that contains reading or writing files commands, one thread was created and used only for accessing the system file system, and all threads were terminated after the task finishes.

Input Data Controller 1210: All input data are controlled by Input Data Controller 1210 (object #21) system. To avoid suspending the program while receiving the run-time data with a high frequency (960 HZ), a separate thread is created for Run-time Simulink Controller 1212 (object #22), which receives and unpacks the real-time Simulink data that is received through the UDP port. Some controller input events can be also received in Input Data Controller 1210 but can be processed in the program's main thread.

Run-time Simulink Controller 1212 can receive head and eye orientation and angular velocity from the custom-developed run-time Simulink program deployed on a remote desktop computer, which collects data from the magnetic field system and eye-tracking glasses. Run-time Simulink Controller 1212 runs on a separate thread created by Input Data Controller 1210 and updates all variables in a high frequency by receiving data from a UDP client. Once the thread started, it creates the UDP client and keeps it running through the entire experiment. The variables can be: HeadRotation: head rotation in quaternion; HeadRotationSpeed: a Unity built-in Vector3 variable which stored the three axes head rotation speed in degrees per second; EyeRotationAngle: two axes rotations in degrees for both eyes (pitch and yaw); EyeRotationSpeed: 2 axes rotation speeds in degrees per second for both eyes (pitch and yaw); Simulink samples: timestamps generated by Simulink program for synchronizing the time of all the log data; UDP client: a port specified UDP client to receive UDP transmission.

Controller Data 1214 (object #23) can determine whether the controller's joystick is being pushed, and if so, in which direction. Controller Data 1214 can also determine whether the controller's shoulder button was pressed. Both events can then be sent to System Controller 1204 through Input Data Controller 1210.

UI System 1206: UI System 1206 (object #3) can be developed that provides two different visual interfaces, one for the participant and one for research staff, along with System Controller 1204 and Camera System 1216 (object #4). To accomplish this, two Unity Camera groups, which inherit the built-in Unity Engine rendering system, can be used in the assessment scene. The first Camera group can capture all objects needed to display to the participants and renders them properly to the dual monitors. The second Camera group can capture mostly the same objects, but instead of rendering them to the dual monitors, it can render to a laptop so that research staff can monitor all the patients' actions in real-time. Different visual interfaces are needed between participants and the staff because some visual objects should be hidden from the participants during the experiment, such as the Head Indicator, but staff should be able to monitor these objects to ensure proper protocol adherence. There is also text information displayed on the staff visual interface that the participants cannot see. The text displays most of the current state information. It contains head rotation angle, current program state, Target Indicator position, current experiment condition, current acuity size, and current acuity delay time. This information allows the staff to monitor patients' performance in real-time and adjusts parameters if needed while not disturbing the participants during the experiment. There are also buttons on the staff's visual interface so that the staff can execute some actions using a computer mouse from the laptop. The “Re-center” button is typically used at the beginning of the experiment to set the Natural Head Position for the program. The patients are first told to focus on the center of the monitor, and by pressing the “Re-center” button, the program records this position and calculates all other rotations relative to this Natural Head Position. The “Quit” button is used to terminate the program. Although all System Setting 1306 in FIG. 12B and the Experimental Condition 1308 in FIG. 12B data are predefined in JSON files by default, it is also possible to change the parameters during the experiment by using the input boxes, drop-down menus, and buttons implemented in UI System 1206, in case any changes from the defaults are desired. Also, since there is a large number of UI components, they are divided among multiple pages. Navigation from one page to the next is accomplished by the “next page” button.

Target System 1402 in FIG. 12C: Target System 1402 (object #12) can generate the main interactive object that patients respond to and provides visual feedback to patients during the assessments. Target System 1402 can include three parts: Target Indicator 1404 (object #13), Target Focusing Indicator 1406 (object #14), and Target Collider 1408 (object #15).

Target Indicator 1404 can be a sphere displayed on the monitor that is used to represent visual targets that the patients are instructed to fixate their gaze upon. It can also change color to give signals to the patients when needed. Target Focusing Indicator 1406 (e.g., displayed as a 9 cm white circle) informs the patients that they are facing the target. The Target Collider 1408 can detect whether participants achieve the expected head rotation angle for each experiment trial. This functionality can be implemented using a ray that is cast from a head model, which is detected by the Target Collider 1408.

One challenge of this display system is that the program may not automatically adjust the size and the position of the displayed content since everything captured by the Camera components were rendered to the monitor. To achieve a one-to-one ratio for both content sizes and positions displayed on the dual monitors, the monitors' field of view was measured, calculated, and applied to the Camera components, so the contents would display the expected contents needed. The calculation is showed as: F=2×arctan(½×h/D). The variable “h” represents the physical heights of the monitor, the “D” represents the distance between the monitor and the player, and “F” is the field of view. The idea is to use the height of the monitor and the distance to calculate the view angle of the monitor, which is applied to the Camera settings.

Vision Acuity Assessment System 1410: Vision Acuity Assessment System 1410 (object #9) can be another component that produces images for the participants to resolve visually so that their visual acuity can be estimated. There can be different types of acuity optotypes, and different sizes can be used to measure the visual acuity accurately. The Vision Acuity Sprite 1412 (object #10) can include 2D sprites that are rendered in a pixel-perfect manner calibrated to match the “Landolt C” visual acuity test symbols.

The main purpose of using this system is to test patients' static and dynamic visual acuities. There are 10 optotype sizes, referred to as size index from 0 to 9, and representing visual acuities of log MAR of −0.182, −0.036, 0.072, 0.232, 0.294, 0.397, 0.516, 0.610, 0.709, and 0.808. The smallest optotype used in the experiments is 25 by 25 pixels, which is defined as size index 0. The next larger optotype is around 0.1 log MAR larger. Since the optotypes' sizes are restricted by the limitation that pixel numbers have to be integers, it is not possible to have optotypes differing by 0.1 log MAR increments. However, the optotypes that are closest to this increment could not be found. Also, since each optotype size needed to be randomly presented in 8 orientations based on the location of the gap in the circle: 0, 45, 90, 135, 180, 225, 270, and 315 degrees, two separate image sets are drawn for each size, one for rotations of 90 degrees and another for rotations of 45 degrees. This can be done to reduce distortion caused by rotating the image used for 90-degree orientations by 45 degrees. In some examples, the first sprite, which is generated only by rotating 90-degree orientation sprites, contains pixels other than black and white. This might affect the patients' judgment since the gap width is not the same as the orthogonally oriented sprites. In contrast, the custom created sprite on the right side of this figure could keep the gap width constant. To avoid input error, the joystick direction is displayed in the form of a large optotype that participants then need to confirm by pressing a button on the controller. The Controller Indicator 1414 (object #11) is a size index of eight (log MAR 0.709) optotype with a different color (e.g., green) that is displayed while participants were pushing the controller's joystick.

Head Simulator component 1502 in FIG. 12D (object #6) can be an object that continuously mirrors the actual head rotation during the experiment. In some examples, the head rotation can be streamed from the Simulink at a high frequency. This object can also contain a Ray Cast Controller component 1504 (object #7) that continuously emits a Unity Ray toward the forward direction of the head. The Unity Ray could collide with the Unity Collider and send event signals to the system, which was handled by the System Controller component 1204.

Systems and processes for real-time diagnosis and treatment of vestibular conditions: The various testing, training, and therapeutic approaches identified above, can be implemented via a number of different configurations and equipment. In this Section, several example implementations will be described.

Certain embodiments may incorporate some or all of the games/therapies identified above, in a smart, real-time system that serves both diagnostic and therapeutic purposes. For example, in some embodiments, a system may be provided that includes a user interface for a clinician or other individual supervising a subject's therapy. The clinician may have already performed a typical assessment of a subject, and can input the clinician's preliminary diagnosis into the user interface, along with other pertinent information regarding the subject (such as age, vision acuity, etc.). In other embodiments, this information may be taken directly from a subject's medical record, such as for example from an optometrist's patient records.

Such an embodiment could then automatically select appropriate therapeutic games correlating to the clinician's preliminary diagnosis, such as from among the types of therapeutic games described above or other games that enforce the same types of eye measurements and movements described above. In some embodiments, the system may ask a user to play a suite of many types of games, using the subject's performance as a method of making preliminary diagnoses of the types of conditions that may be present. In this sense, the system can use therapeutic games in a dual-purpose way: to suggest possible conditions/deficiencies in a diagnostic phase, and to provide therapy in a therapeutic phase. When used as a diagnostic, the system may ask the user to play all available games, and may record the user's performance at increasing levels of difficulty. Those games for which the user did not achieve a high-enough score, could be recommended to the clinician. The clinician's user interface could present the selections to the clinician for confirmation.

The confirmed therapeutic game(s) would then be queued to be played by the subject. In some embodiments, the subject may select which game to play first, second, etc. In other embodiments, the clinician's user interface will allow the clinician to prescribe the specific order and duration of the game(s). In yet further embodiments, the system may set the order of games according to which tend to fatigue the subject's eyes the most. For example, if most subjects playing a first game tire their eyes such that it is too difficult to play the next game at an expected level, then the system may “learn” to suggest reversing the order of the games. In other words, if most subjects who play game B after game A achieve a “score” significantly below expectation, but the reverse is not true, then the system may suggest that game B be played first.

Next, the first queued game will be displayed to the subject. As described above, in some implementations this may be done via an AR or VR headset. In other implementations, this may be performed via another type of screen shown to a user. The equipment may be self-contained (e.g., a unit that is “rented” from a clinician by the subject for frequent use), or may be implemented solely by a screen and computer at the clinic. During play of the first game, the system records subject performance data. This data can be benchmarked against the subjects own profile of past performance and/or against other benchmarks (such as performance of similar users). If the subject is performing below expectation, the system can ease the difficulty of the game in real time so that the subject can obtain more beneficial therapy. For example, a threshold level of success can be predetermined, below which the game must be eased. Alternatively, the system can monitor performance and determine if a subject has become too fatigued to continue at the same level (e.g., even if the user's average is still above a given threshold, but the user has gotten the last 3, 4, 5, . . . 10, etc. games incorrect), and if so can ease the difficulty of the game. Similarly, if the system determines that the user is getting too high of a percentage of the games correct, or is otherwise significantly exceeding expectation, the system can dynamically increase the difficulty of the game. In some embodiments, where a user is performing about as expected, the system may be designed to briefly increase and/or the difficulty of the game to test whether the user is capable of a higher degree of difficulty, or whether there may be some aspect of the game (other than difficulty) that is causing wrong answers. For example, by increasing and decreasing difficulty, the system may be able to detect instances of a user's performance not showing an associated decrease or increase. This may be evidence of an external factor, like the user not understanding the game or an equipment problem.

In addition to performance data, some embodiments may also collect additional subject status. E.g., the system may allow for a user to input whether the user is feeling dizzy, nauseous, sick, vertigo, etc. Other measurements could also be taken, such as heart rate, blood pressure, balance, and subject movement. This data is then stored in the subject's profile associated with the specific game/date of the therapy.

Next, if prescribed, a second (and subsequent, if applicable) game can be played by the subject, via the same equipment as the first game. As with the first game, the system will store a variety of data concerning the subject's performance and experience. And, the system may increase/decrease difficulty of the game dynamically according to performance.

Once all prescribed games have been completed for the prescribed duration/difficulty, the system can present a report to the clinician of the subject's performance, along with recommendations for prescribing a next set of games. In some embodiments, the system may prescribe increasing difficulty for each subsequent therapy session according to observed performance of other users. In other embodiments, the system may prescribe increasing (or decreased) difficulty for the subsequent therapy session based upon the subject's own past performance (e.g., if the subject was unable to keep up with a game at a prescribed difficulty level in the last therapy session to a sufficient degree, then the system may prescribe the same difficulty, a lesser difficulty, or a difficulty only slightly higher). And, the degrees of difficulty, and changes in degrees of difficulty may be different across the games to be played by the subject.

The clinician user interface can allow for the clinician to accept or modify the recommendations. Or the clinician may determine that further therapy based on the selected games is not necessary.

Reference is made to FIGS. 1-12, which depict examples of the foregoing methods in flowchart form. As noted above, such functionality can be achieved via portable/at-home systems or via systems in a clinician's office. In some embodiments, the system may suggest that, after a certain amount of therapy in-clinic, the subject is ready for at-home therapy and can suggest a portable/at-home device and/or an app.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A method for dynamic ocular training, comprising:
receiving an indication of an ocular disorder of a patient;
selecting a virtual reality therapeutic game from a set of available virtual reality therapeutic games, wherein each of the set of available virtual reality therapeutic games is designed to provide therapy for one or more of a given set of ocular disorders, the virtual reality therapeutic game being selected based on the indication of the ocular disorder, the selected virtual reality therapeutic game being designed to provide therapy for the ocular disorder;
performing the virtual reality therapeutic game via a display screen to the patient, and receiving a patient input during performance of the virtual reality therapeutic game;
determining a current success level of the patient for the virtual reality therapeutic game based on the patient input; and
dynamically adjusting a difficulty level of the virtual reality therapeutic game based on the current success level of the patient.

2. The method of claim 1, wherein dynamically adjusting the difficulty level of the virtual reality therapeutic game comprises: automatically increasing or decreasing the difficulty level based on the current success level compared to one or more previous success levels of the patient, the one or more previous success levels being determined based on previous patient inputs.

3. The method of claim 1, wherein the difficulty level of the virtual reality therapeutic game is adjusted further based on a therapist input of a therapist.

4. The method of claim 3, wherein the therapist input comprises an updated difficulty level of the difficulty level.

5. The method of claim 1, further comprising:
automatically selecting another virtual reality therapeutic game, the another virtual reality therapeutic game being different from the virtual reality therapeutic game, the another virtual reality therapeutic game being designed to provide therapy for the ocular disorder.

6. The method of claim 1, further comprising:
automatically transmitting a notification to a therapist based on the current success level of the patient.

7. The method of claim 1, further comprising performing a virtual eye position calibration,
wherein the virtual eye position calibration comprises:
displaying a series of horizontal and vertical virtual target locations on the display screen to create a calibration map;
detecting eye positions for the series of horizontal and vertical virtual target locations;
mapping the eye positions to the series of horizontal and vertical virtual target locations to produce a calibration scale parameter; and
calibrating the display screen based on the calibration scale parameter,
wherein the eye positions for the series of horizontal and vertical virtual target locations comprise:
right eye positions corresponding to the series of horizontal and vertical virtual target locations,
left eye positions corresponding to the series of horizontal and vertical virtual target locations, and
binocular positions corresponding to the series of horizontal and vertical virtual target locations.

8. The method of claim 1, further comprising performing a vergence capacity measurement, and
wherein the vergence capacity measurement comprises:
displaying, via the display screen, a virtual target at a first distance away from two positions corresponding to eyes of the patient;
moving the virtual target from the first distance to a center of the two positions at a constant speed;
receiving a measurement input when the patient perceives loss of convergence for the virtual target; and
producing the indication of the ocular disorder based on the measurement input.

9. The method of claim 8, wherein the vergence capacity measurement further comprises:
repeating displaying, via the display screen, the virtual target, moving the virtual target, and receiving a subsequence patient input when the patient perceives loss of convergence for the virtual target; and
measuring vergence fatigue based on the subsequence patient input.

10. The method of claim 1, further comprising performing a reading measurement, and
wherein the reading measurement comprises:
displaying, via the display screen, different levels of words at different vergence angles;
receiving measurement inputs corresponding to the words;
determining a speed and an accuracy level of each of the measurement inputs; and
producing the indication of the ocular disorder based on the speed and the accuracy level of each of the measurement inputs.

11. The method of claim 1, wherein the virtual reality therapeutic game incorporates tasks that simulate near work or rapid changes of fixation between near and far viewing distances.

12. The method of claim 1, wherein performing the virtual reality therapeutic game comprises:
displaying, via the display screen, a handle, a route roadway, and a navigator placed closer to the route roadway, the navigator displaying a map including the route roadway;
displaying, via the display screen, a driving map direction on the navigator; and
receiving the patient input indicative of a driving vehicle direction on the route roadway, and
wherein the current success level increases in response to the driving vehicle direction being equal to the driving map direction.

13. The method of claim 1, wherein performing the virtual reality therapeutic game comprises:
displaying, via the display screen, a first object with a first depth falling from a top to a bottom;
displaying, via the display screen, a second object with a second depth falling from the top to the bottom, the second depth being different from the first depth; and
receiving the patient input to catch the first object and the second object, and
wherein the current success level increases in response to the patient input catches the first object and the second object.

14. The method of claim 1, wherein performing the virtual reality therapeutic game comprises:
displaying, via the display screen, an oncoming obstacle toward a main character;
displaying an optotype over or next to the main character;
receiving the patient input; and
in response to the patient input corresponding to an orientation of the optotype, displaying the main character avoiding the oncoming obstacle and increasing the current success level.

15. The method of claim 1, wherein performing the virtual reality therapeutic game comprises:
displaying, via the display screen, an oncoming obstacle toward a main character;
displaying a random stereo dot image containing a symbol representing a different lane to avoid the oncoming obstacle;
after disappearing the random stereo dot image, receiving the patient input; and
in response to the patient input corresponding to a direction toward the different lane, displaying the main character avoiding the oncoming obstacle and increasing the current success level.

16. A therapeutic system for treatment of disorders, comprising:
a memory; and
a processor communicatively coupled to the memory,
wherein the memory stores a set of instructions which, when executed by the processor, cause the processor to:
select a virtual reality therapeutic game among a plurality of therapeutic games based on a diagnosis result;
perform the virtual reality therapeutic game to receive a patient input in the virtual reality therapeutic game;
dynamically adjust a difficulty level of the virtual reality therapeutic game based on the patient input; and
transmit a game result to a device associated with a therapist, the device remote from the therapeutic system, based on the difficulty level of the virtual reality therapeutic game and the patient input.

17. The therapeutic system of claim 16, wherein the set of instructions, when executed by the processor, further cause the processor to:
receive an updated setting from the device associated with the therapist, and
wherein the virtual reality therapeutic game is selected further based on the updated setting.

18. The therapeutic system of claim 16, wherein the set of instructions, when executed by the processor, further cause the processor to:
receive an updated setting from the device associated with the therapist, and
wherein the difficulty level of the virtual reality therapeutic game is determined further based on the updated setting.

19. The therapeutic system of claim 16, further comprising:
a virtual reality headset for display of the virtual reality therapeutic game; and
an input device for the patient input.

20. The therapeutic system of claim 16, wherein the set of instructions, when executed by the processor, further cause the processor to:
automatically transmit a notification to the therapist based on the patient input.

21. The therapeutic system of claim 16, wherein the virtual reality therapeutic game provides therapy for a vestibular disorder.

22. The therapeutic system of claim 16, wherein the virtual reality therapeutic game comprises a soccer game.

23. The therapeutic system of claim 16, wherein the one virtual reality therapeutic game provides therapy for a disorder in a monocular right eye, a monocular left eye, or a binocular vision.
